(19) United States
(12) Patent Application Publication
(10) Pub. No.: US 2024/0330801 A1
(43) Pub. Date: Oct. 3, 2024

(54) SYSTEM AND METHOD FOR MANAGING DISRUPTIONS WITHIN A TRANSPORTATION SYSTEM USING DELAYS AND CANCELLATIONS OF TRAVEL LEGS

(71) Applicant: AMERICAN AIRLINES, INC., Fort Worth, TX (US)

(72) Inventors: Yuqiang Wang, Southlake, TX (US); Shouvik Dutta, San Francisco, CA (US); Sheng Xu, Grapevine, TX (US); Duaa Serhan, Euless, TX (US); Sharadha Raghunathan, Grapevine, TX (US); Denise Gonzales, Irving, TX (US); Steven Olson, Colleyville, TX (US); Robert Shirley, Keller, TX (US)

(21) Appl. No.: 18/481,574

(22) Filed: Oct. 5, 2023

Related U.S. Application Data
(60) Provisional application No. 63/492,450, filed on Mar. 27, 2023.

(51) Int. Cl. G06Q 10/0631; G06F 3/0482; G06F 3/0484; G06Q 10/04; G06Q 50/30

(52) U.S. Cl. CPC G06Q 10/06312; G06F 3/0482; G06F 3/0484; G06Q 10/04; G06Q 10/063118; G06Q 10/06313; G06Q 10/06315; G06Q 50/40

(57) ABSTRACT

A system and method that includes displaying a graphical depiction of projected demand, with values of the projected demand calculated using a constraint, over a future period of time; displaying, over the graphical depiction, a selectable graphical element at a first position that is associated with a first value of the constraint; and wherein the selectable graphical element is adjustable to change the value of the constraint; receiving an indication that the selectable graphical element has been adjusted to a second position associated with a second value of the constraint; and updating the graphical depiction using updated values for projected demand over the future period of time. Projected demand may be part of transportation-related data, on which basis a recommended management plan for a disruption may be identified, the plan being identified with a network model and including strategic travel leg delays and strategic travel leg cancellations.

### CROSS-REFERENCE TO RELATED APPLICATION

This application claims the benefit of the filing date of, and priority to, U.S. Application No. 63/492,450, filed Mar. 27, 2023, the entire disclosure of which is hereby incorporated herein by reference.

### BACKGROUND

The present disclosure relates in general to a system and method for managing disruptions within a transportation system, such as, for example, air, land or sea transportation systems, and in particular to a system and method for managing disruptions using intentional impositions of cancellations and delays of travel legs when one or more vehicles that arrive at, and depart from, one or more specific locations.

Generally, existing systems in the technical field of disruption management during irregular operations (“IROPs”) include an optimization model providing only delay solutions and only consider gating constraints. Thus, existing systems lack the capability of rescheduling an airline's operations based on gating constraints, arrival rate constraints, and departure rate constraints among other constraints and considerations. Moreover, with existing systems, cancellations and delays are considered independently, which creates a problem in the technical field of disruption management during IROPs. In some embodiments, delaying a flight preserves the ability of the flight crew to travel to the next destination on its scheduled flight, albeit later in time. When considering cancellation of flights, a new plan must be created to move the flight crew to its next destination. That is, the return of a flight crew to a source location or transfer of that flight crew to another intermediate location before returning to the source location must be identified and assigned. When combining the legalities associated with the crew, the problem becomes very complex. Similar complexities arise with the routing of an aircraft when flights are cancelled. These problems in the technical field of disruption management during IROPs can result in flights being cancelled or delayed over a number of days, hundreds of millions of dollars lost for extra costs associated with passenger reimbursements and accommodations, and premium pay for crew. In addition to monetary losses, the inadequate management of IROPs can result in thousands of customers being stranded for days. Using existing systems, there can be disruptions even days after the source that caused the IROPs ceases because aircraft and crews sequences are still being repaired.

### BRIEF DESCRIPTION OF THE DRAWINGS

FIG. 1 is a diagrammatic illustration of a system according to an example embodiment, the system including a plurality of data sources and a computer.

FIG. 2 is a diagrammatic illustration of a portion of a network model created by the system of FIG. 1, according to an example embodiment.

FIG. 3 is a diagrammatic illustration of the plurality of data sources of FIG. 1, according to an example embodiment.

FIG. 4 is a flow chart illustration of a method of operating the system of FIG. 1, according to an example embodiment.

FIGS. 5-6 are diagrammatic illustrations of portions of the network model of FIG. 2, according to an example embodiment.

FIG. 7 is a chart that illustrates multiple time buckets referenced by the system of FIG. 1, according to an example embodiment.

FIGS. 8-9 are charts that illustrates gate demand and gate capacity referenced by the system of FIG. 1, according to an example embodiment.

FIG. 10 is a diagrammatic illustration of a portion of the network model of FIG. 2, according to an example embodiment.

FIGS. 11A and 11B together illustrate a user interface created and displayed by the system of FIG. 1, according to an example embodiment.

FIGS. 12-19 illustrate user interfaces created and displayed by the system of FIG. 1, according to an example embodiment.

FIGS. 20A and 20B together illustrate a graphical user interface created and displayed by the system of FIG. 1, according to an example embodiment.

FIG. 21 is a diagrammatic illustration of the computer of FIG. 1, according to an exemplary embodiment.

FIG. 22 is a diagrammatic illustration of a computing device for implementing one or more example embodiments of the present disclosure, according to an example embodiment.

### DETAILED DESCRIPTION

The following disclosure provides many different embodiments or examples. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

The HEAT (“Hub Efficiency Analytical Tool”) system disclosed herein includes an advanced optimization model that provides a joint delay and cancel solution for managing IROPs. Examples of IROPs include weather events, ramp closure(s), and gate unavailability. A joint delay and cancel solution, by definition, is superior to a delay-only solution and provides an improvement to the problems associated with delay-only solutions described above. The HEAT system has the capability of rescheduling an airline's operations based on gating constraints, arrival rate constraints, and departure rate constraints while existing systems only consider the gating constraints. Another improvement in the technical field of disruption management during IROPs relates to the HEAT system having an intelligent, advanced user interface (“UI”). That is, existing graphical user interface (“GUI”) or UI technology involves many structural (e.g., arrangement and/or presence of specific input elements in the display) drawbacks and deficiencies that result in reduced functionality of the GUI itself as well as a less useful and less accurate final product when the UI is used to calculate a product or solution. In one embodiment, the HEAT system is a decision support tool that monitors and efficiently recovers operations based on capacity constraints by recommending joint delays and cancellations for mainline and regional flights. Moreover, the HEAT system provides an overall view of the status of hubs in a hub-and-spoke travel network, in addition to providing tools to help make decisions during IROPs. Generally, a hub-and-spoke travel network includes routes where an airline or other transportation entity not only transports passengers between two points but also connects the passengers of distant points via its hub. The HEAT system finds the set of flights to be canceled or delayed, and the amount of delay for each flight that minimizes the impact on passenger and crew.

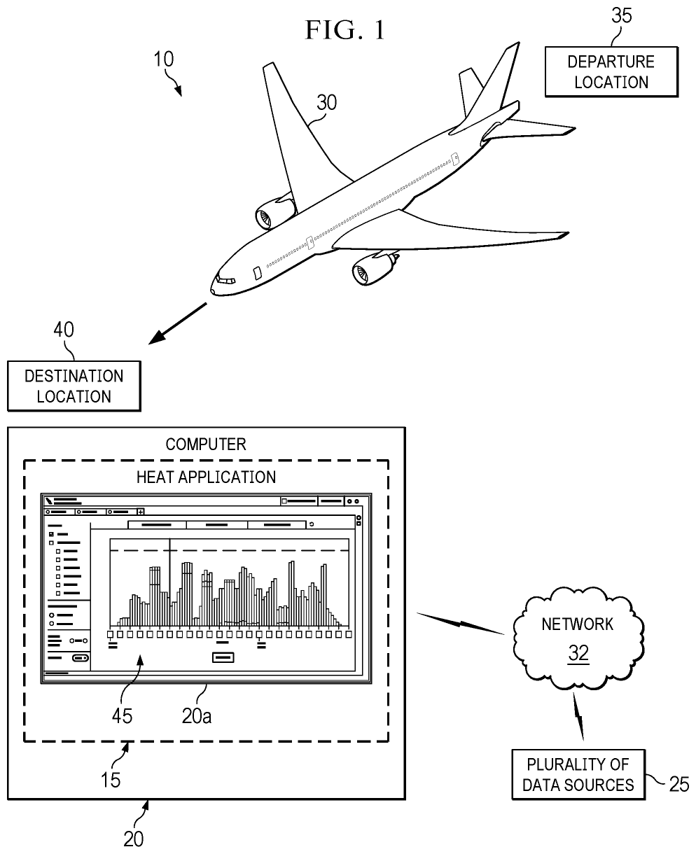

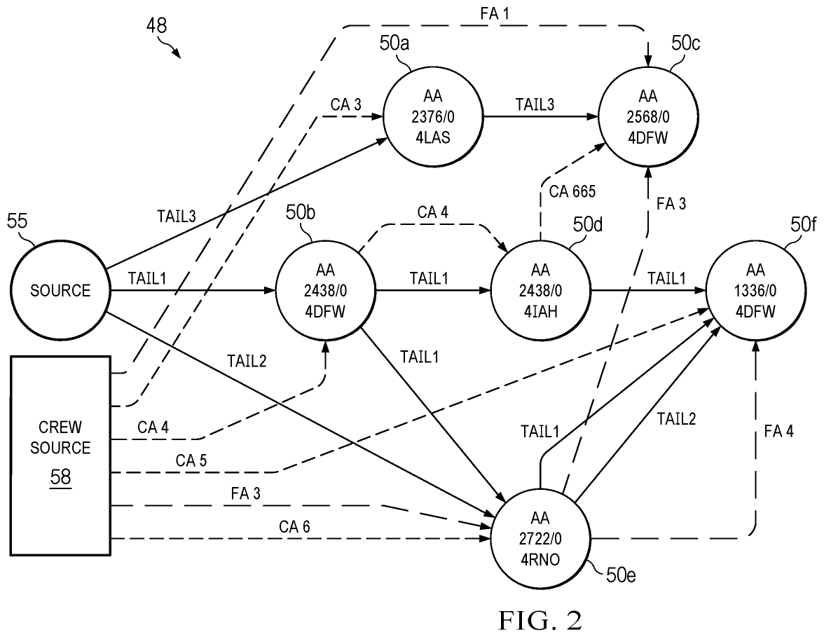

In an example embodiment, as illustrated in FIG. 1, the HEAT system is generally referred to by the reference numeral 10 and includes a computer application, such as a HEAT application, referred to by numeral 15, and a computer 20 within which at least a portion of the application 15 is stored. In one embodiment, a plurality of data sources 25 receives data relating to transportation systems and is in communication with the computer 20 via a network 32. In one embodiment, the plurality of data sources 25 receives data relating to flight operations or other travel leg operations. In one embodiment, the plurality of data sources 25 receives data relating to a flight from a plurality of flights, the flight using an airplane 30 and having a departure location 35 and a destination location 40. Severe weather at the destination location 40 can result in ramp closures, extensive air traffic control delays and/or cancellations, and flight diversions at the destination location 40, all of which can result in major disruptions to a flight schedule associated with the aircraft or airplane 30 and passengers scheduled to fly on the airplane 30. Delays and cancellations can propagate through a network model 48 (illustrated in FIG. 2), which can include the flight associated with the airplane 30 among others. In several embodiments, after receiving transportation-related data from the plurality of data sources 25, the system 10, using a monitor mode, may anticipate delays from operational irregularities, such as impending gate congestion, misconnecting customers, or flight cancellations, before they actually occur by propagating existing flight delays and anticipating the effect of each flight's delay on any other flight. In one embodiment, the application 15 reschedules an airline's aircraft in a real time or near real time fashion as an orchestrated response to meet operational constraints imposed to the airline by weather or other factors. In one embodiment, the transportation-related data is flight operations related data. Returning to FIG. 1, the proposed delays and cancellations can be listed in a window 45 displayed on a GUI 20a of the computer 20 or other computer. In one embodiment, the HEAT application 15 accesses data from a plurality of data sources 25; creates proposed strategic delays and cancellations of flights to manage reduced airport capacity, prevent customer misconnects, and satisfy operational constraints; and then displays these results by outputting plan parameters on the GUI 20a via the window 45, using a recovery mode. In one embodiment, the creation of strategic delays of flights or cancellations of flights, within the recovery mode, may be based on inputs from a user via an improved UI.

In one embodiment, the HEAT application 15 employs advanced optimization algorithms that reschedule an airline's aircraft in a real time or near real time fashion as an orchestrated response to meet operational constraints imposed to the airline by weather or other factors. Such an algorithm produces an optimized new schedule that protects the crew schedule and turn operations while minimizing potential impact to the airline's customers' itineraries due to the disruption. The problem of rescheduling and managing aircraft and crew is complex due to system complexities, crew complexities, passenger complexities, station complexities, and aircraft complexities. For example, system complexities stem from the use of a single hub, mainline and regional operations, delays and cancellations of flights, and computational time (e.g., 1-3 minutes); crew complexities stem from crew sequences, crew legalities, recoverability and reserve issues, and integrating with existing applications such as Crew Watch/Recovery; passenger complexities stem from itineraries, value, and protection opportunities; station complexities stem from gate capacity, arrival rates, and departure rates among others; and aircraft complexities stem from minimum on ground time (“MOGT”) requirements and preserving routing issues. In addition, there are additional complexities relating to the scope of the solution, which includes delays and cancellations, mainline and regional joint optimization, and minimal computational time requirements. In addition, there are additional complexities relating to the integration of the HEAT application 15 with other systems, including an order management system that provides centralized access to order management within a single system, with an order being associated with the information that comes from the customer side, a tool or other resource for planning airplane deicing operations, a tool or system that relinks missing files, and others. In some embodiments, the HEAT application 15 allows for IROP simulations such as diversions, ramp closures, and ground stop (“GS”)/ground delay program (“GDP”).

FIG. 2 is a diagrammatic illustration of a portion of the network model 48 with flights represented as nodes 50a, 50b, 50c, 50d, 50e, and 50f. Resources flowing between flights (aircraft and crew) are arcs. For example, if there is a turn at DFW where the inbound flight is AA1 and the outbound flight is AA2, the network model includes a flow AA1→AA2, where AA1 and AA2 are nodes, and an arc connects them. For example, “Tail 1” is an arc representing an aircraft that connects the node 50b associated with AA 2438/04 DFW and node 50d associated with AA 2438/0 4IAH. Generally, a tail number is an aircraft identifier. In some embodiment, the construction or creation of the network model 48 includes identifying “source” flights. One example of a “source” flight is represented by node 55 in FIG. 2. These “source” flights are basically the “origin” for each aircraft and are calculated by finding the first flight for each tail after a model start time, which is a time associated with the beginning of the time period for which a solution should be generated. From there, if a previous leg or flight exists, that is treated as the source. If there is no previous leg, then the leg is treated as the source. Generally, and for a majority of cases, a previous leg exists, so the source flight would be the last flight of a tail before the model start time. From there, the graph or network model 48 is built such that an arc is built between any two flights that can be connected. In some embodiments, the network model 48 contains logical information such as connectivity relationships among nodes and links, directions of links, and costs of nodes and links. In some embodiments, flights can be connected if the timing works (within a buffer), if the flights use compatible sub fleets, if the flights connect at the same station, etc. FIG. 2 also illustrates crew data, which is more difficult because the sequences are not always coherent, and instead lack consistency and orderly continuity. For example, the employees that comprise the crew for one flight may be dispersed among many downline flights. Additionally, a variety of crew positions may be required for every flight, and therefore, the employees must be matched with their crew position and scheduled on a flight that needs that crew position. As such, the sequences for crew are more complex than the sequences for aircraft. In some embodiments, the HEAT application 15 recreates the linkages by employee number and then connects every crew leg to its downline legs from the same station just like aircraft. Crews also have a specific source, illustrated by the numeral 58 in FIG. 2. In some embodiments, the HEAT application 15 makes some assumptions that in certain crew bases (provided in the input), a limited number of new crew may be found. Arcs are made from the crew source node to any flight departing from one of these crew bases. For example, “CA4” is an arc representing a crew member that connects the node 50b associated with AA 2438/04 DFW and node 50d associated with AA 2438/0 4IAH.

Disruption to the illustrated network model 48 can be caused by for example, weather events, ramp closures, and gate unavailability, and may be referred to as irregular operations. As noted above, these disruptions can cause congestion and delays, which propagates through the airline system operations over time and across locations. For example, a weather event that requires aircraft to undergo a deicing process can reduce the departure rate and cause delays at one location, which can cause a delay in a “downstream” location that is awaiting use of the delayed aircraft. Regarding the deicing process, aircraft are designed to fly with clean surfaces, and during colder periods of the year, icy materials can build up, disrupt airflow, and interfere with a safe take-off. Deicing is the process of removing snow, ice, or frost from an aircraft's surface. Generally, in addition to removing ice or snow, an anti-icing fluid will be applied to the aircraft surface to prevent ice from forming. The deicing process reduces the number of flights to depart from an airport because additional time is required in the departure process. Regardless of the type of initial delay, the effects can be magnified due to the complexities and dependencies of the network, specifically the crew, aircraft, station or airport limitations, and passenger connections. The cost of delays and cancellations can result in billions of dollars lost, as well as lost goodwill with customers and crews. In order to create the network model 48, monitor delays, including past, existing, future and predicted delays, data is accessed from the plurality of data sources 25.

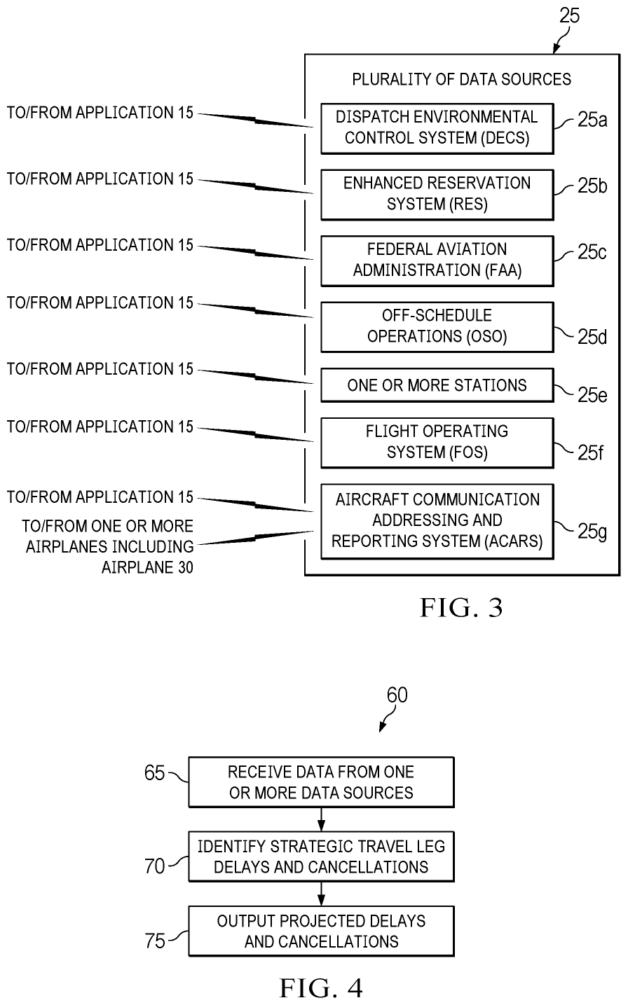

In an example embodiment, as illustrated in FIG. 3 with continuing reference to FIG. 1, the plurality of data sources 25 includes a dispatch environmental control system (DECS) 25a and/or one or more computer systems, host-based systems and/or applications thereof; an enhanced reservation system (RES) 25b and/or one or more computer systems, host-based systems and/or applications thereof; the Federal Aviation Administration (FAA) 25c and/or one or more computer systems, host-based systems and/or applications thereof; off-schedule operations (OSO) 25d and/or one or more computer systems, host-based systems and/or applications thereof; one or more stations 25e such as, for example, a station at the departure location 35 and/or a station at the destination location 40, and/or one or more computer systems, host-based systems and/or applications thereof; a flight operating system (FOS) and/or one or more computer systems, host-based systems and/or applications thereof, and an aircraft communication addressing and reporting system (ACARS) 25g and/or one or more computer systems, host-based systems and/or applications thereof.

In an example embodiment, as illustrated in FIG. 4 with continuing reference to FIGS. 1-3, a method of managing disruptions within a transportation system, by operating the system 10, is generally referred to by the reference numeral 60. In an example embodiment, the transportation system is associated with a plurality of airline flights, each of which departs from a station at a departure location and arrives at a station at an arrival location. In several example embodiments, the method 60 is implemented by, or at least partially implemented by, the computer 20 of the system 10. In one embodiment, the method 60 includes receiving data from the plurality of data sources 25 at step 65, identifying strategic travel leg delays and cancellations at step 70, and outputting projected delays and cancellations at step 75.

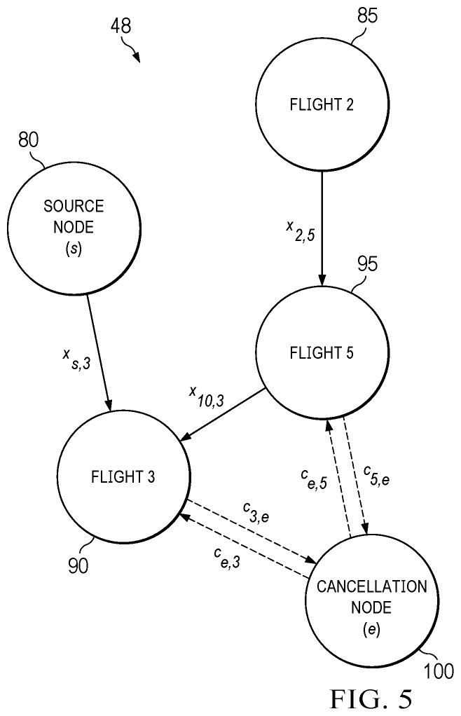

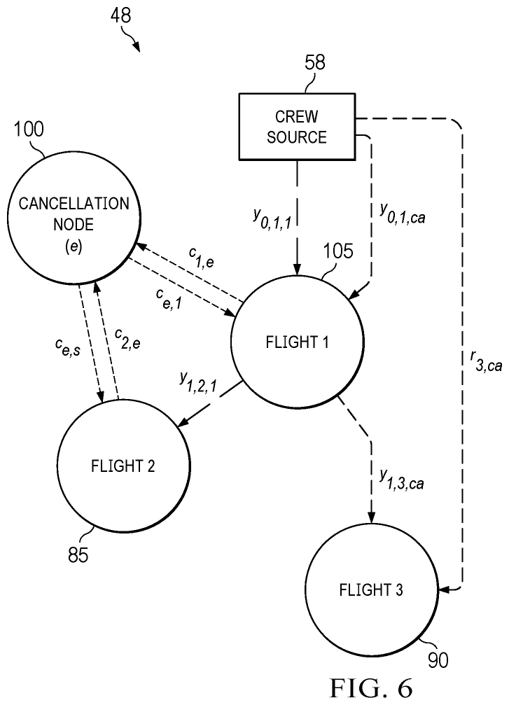

In an example embodiment, at the step 65, the HEAT application 15 accesses data-such as flight schedule, crew sequences, aircraft routings, passenger connections, crew duty and layover data, curfew data, gate capacity, and model start and end time—from one or more of the following: the computer 20; the DECS 25a; the RES 25b; the FAA 25c; the OSO 25d; the one or more stations 25e; the FOS 25f; and the ACARS 25g. In several embodiments, the types of data received in the step 65 include, but are not limited to, flight-related data, station-related data, crew data, passenger data, and other transportation system related data. The HEAT application 15 creates, using the data, a mathematical representation of the transportation system as a network model. One example of a portion of a network model is the network model 48. The network model includes a plurality of travel leg nodes, with each travel leg (e.g., AA 2722) represented by a travel leg node (e.g., node 50e in FIG. 2); a plurality of leg source nodes, wherein vehicle or aircraft has a leg source represented by a leg source node (e.g., source node 58). The network model also includes a plurality of crew source nodes, with each crew member having a crew source represented by a crew source node; and a plurality of cancellation nodes. A cancellation node and a cancel node refer to a “sink” or “dummy” node, which in some embodiments allow for the network model to be balanced. The network model also includes a plurality of crew links; wherein each crew link extends between: a travel leg node; and a crew source node or another travel leg node; and wherein each of the crew links represents a flow of a crew member between: a travel leg represented by the travel leg node; and a crew source node or another travel leg represented by the another travel leg node. The network model also includes a plurality of reserve crew links; wherein each reserve crew link extends between: a travel leg node; and a crew source node or another travel leg node; and wherein each of the reserve crew links represents a flow of a reserve crew member between: a travel leg represented by the travel leg node; and a crew source node or another travel leg represented by the another leg travel node. The network model also includes a plurality of vehicle links; wherein each vehicle link extends between: a travel leg node; and a leg source node or another travel leg node; and wherein each of the vehicle links represents a flow of a vehicle between a travel leg represented by the travel leg node; and a leg source node or another travel leg represented by the another travel leg node. The network model also includes a plurality of cancel links; wherein each cancel link extends between a cancellation node and a travel leg node; and wherein each of the cancel links represents cancellation of a travel leg associated with the linked travel leg node. The network model 48 illustrates, for clarity purposes, a small network involving less than 10 flights. The network model generated by the HEAT application 15 involves hundred and thousands of flights that are within a period of time between the start time and end time of the model. FIG. 5 is a diagrammatic illustration of a portion of the network model 48 relating to flights and aircraft. As illustrated, nodes 80, 85, 90, 95, and 100 represents a source node s, Flight 2, Flight 3, Flight 5, and a Cancel node e, respectively. Arcs extend between the nodes, with arc x_{i,j} representing a tail of flight i being used for flight j; and c_{i,e} and c_{e,j} representing a cancelled flight. For example, arc x_{s,3} represents the tail of the source node s being used for Flight 3, x_{2,5} represents the tail of Flight 2 being used in Flight 5. Arcs are formed for potential cancellations as well. For example, cancellation arc c_{e,5} represents a cancellation of Flight 5. The network model 48 also accounts for crew variables. FIG. 6 is a diagrammatic illustration of a portion of the network model 48 that represents flights and crew. As illustrated, nodes 105, 85, 90, and 100 represent Flight 1, Flight 2, Flight 3, and the cancel node e, respectively. Arc y_{i,j,k} represents a crew position k of flight i working flight j and arc r_{i,k} represents a reserve crew for flight i position k. In some embodiments, the arcs include or are assigned a value. In some embodiments, the value includes one or more of a monetary value, a period of time, a value that indicates whether a reserve crew is included, etc.

Before, during or after the step 65, the HEAT application 15 identifies strategic travel leg delays and cancellations at step 70. In order to identify strategic travel leg delays and cancellations, the HEAT application 15 uses the network model. In an example embodiment, the HEAT application 15 uses a mixed-integer program, with the parameters below, which can be received from the computer 20 and/or the plurality of data sources 25:
cᵢₑ: 1 if flight i is cancelled, otherwise 0
dᵢ: Flight i delay (in minutes)
e: Cancel node
rᵢₖ: 1 If crew position k assigned on flight i is assigned to reserve
s: Source node
xᵢⱼ: 1 if a tail from flight i flows to flight j, otherwise 0
yᵢⱼₖ: 1 if crew member k flows from flight i to flight j, otherwise 0
zᵢₖ: 1 if flight i arrives in bucket k, otherwise 0
Aᵢ: Scheduled arrival time of flight i
Bₖ^{st}, Bₖ^{end}: Start and end times of time bucket k
Dᵢ: Scheduled departure time of flight i
Fₗ: Set of all flight assigned to be operated by tail l
I: Set of flights nodes
L: Set of tails
Pₗ: Set arcs i, j can be swapped with tail l
Xᵢₜ: 1 if flight i departs in bucket k, otherwise 0
AS: Departure set
DS: Departure set
SCᵢ: Connection slack for flight i
SGₖ: Gate demand slack for time k
SAₖ: Arrival rate slack for time k; and
SDₖ: Departure rate slack for time k

In one embodiment, the HEAT application 15 uses a mixed-integer program with weighted objectives to minimize delays, cancellations, capacity violations (e.g., gate demand, arrival rate, departure rate), and extra crew usage. In an example embodiment, using the foregoing mixed-integer parameters, the mixed-integer program used at the step 70 can be mathematically written as follows:

$$Minimize : Sum ( Weighted delays ) + Sum ( Weighted cancelations ) + {\sum }_{k} {SG}_{k} \times gate penality + {\sum }_{k} {SA}_{k} \times Arrival penality + {\sum }_{k} {SD}_{k} \times Departure penality + {\sum }_{k} {SD}_{k} \times Departure penality \qquad ( 1 )$$

### Subject to:

$${\sum }_{i} {x}_{ij} + {c}_{ej} = 1 ∀ j ∈ I , \qquad ( 2 )$$

$${\sum }_{i} {x}_{ij} + {c}_{ie} = 1 ∀ i ∈ I , \qquad ( 3 )$$

$${c}_{ie} = {c}_{ei} ∀ i ∈ I \qquad ( 4 )$$

$${\sum }_{i} {y}_{ijk} + {c}_{ej} + {r}_{jk} = 1 ∀ j ∈ I , k ∈ K \qquad ( 5 )$$

$${\sum }_{j} {y}_{ijk} + {c}_{ei} = 1 ∀ i ∈ I , \qquad ( 6 )$$

$${\sum }_{i} {\sum }_{k} {r}_{ik} \leq MaxReserve ∀ i ∈ I , k ∈ K \qquad ( 7 )$$

$${d}_{j} + {D}_{j} \geq {MOGT}_{ij} + {A}_{i} * {x}_{ij} + {d}_{i} + {SC}_{j} ∀ i , j ∈ I \qquad ( 8 )$$

$${d}_{i} \leq MaxFlightDelay \qquad ( 9 )$$

$${d}_{j} + {D}_{j} \geq {CrewTurn}_{ij} + {A}_{i} * {y}_{ijk} + {d}_{i} + {SC}_{j} ∀ i , j ∈ I , k ∈ K \qquad ( 10 )$$

$${maxLegalDelay}_{jk} = max ( Crew Max Out Position - LTD , PTD - LTD ) \qquad ( 11 )$$

$${d}_{i} \leq {y}_{ijk} * {maxLegalDelay}_{jk} + ( 1 - {y}_{ijk} ) * maxFlightDelay ∀ i , j ∈ I , k ∈ K \qquad ( 12 )$$

$${\sum }_{t} {B}_{t}^{str} {X}_{it} \leq {A}_{i} + {d}_{i} ∀ i ∈ AS \qquad ( 13 )$$

$${A}_{i} + {d}_{i} \leq {\sum }_{t} {B}_{t}^{end} {X}_{it} ∀ i ∈ AS \qquad ( 14 )$$

$${\sum }_{t} {B}_{t}^{str} {X}_{it} \leq {D}_{i} + {d}_{i} ∀ i ∈ DS \qquad ( 15 )$$

$${D}_{i} + {d}_{1} \leq {\sum }_{t} {B}_{t}^{end} {X}_{it} ∀ i ∈ SD \qquad ( 16 )$$

$${\sum }_{t} {X}_{it} = 1 ∀ i ∈ I \qquad ( 17 )$$

$${\sum }_{i ∈ AS} {X}_{it} \leq ArvlRate + {SA}_{t} ∀ t ∈ T \qquad ( 18 )$$

$${\sum }_{i ∈ DS} {X}_{it} \leq DepRate + {SD}_{t} ∀ t ∈ T \qquad ( 19 )$$

$$g + {\sum }_{i ∈ AS} {\sum }_{0}^{t} {X}_{it} - {\sum }_{i ∈ DS} {\sum }_{0}^{t - 1} {X}_{it} \leq MaxGate + {SG}_{t} ∀ t ∈ T \qquad ( 20 )$$

$${\sum }_{i} {c}_{is} = {\sum }_{i} {c}_{si} \qquad ( 21 )$$

$${\sum }_{i} {c}_{is} \leq MaxCancelations \qquad ( 22 )$$

$${D}_{l} \leq {c}_{si} ∀ i ∈ {F}_{l} , l ∈ L \qquad ( 23 )$$

$${x}_{ij} \leq {D}_{l} ∀ i , j ∈ {P}_{l} \qquad ( 24 )$$

In several example embodiments, the objective of function (1) is to minimize delays, cancellations, capacity violations, and extra crew usage. In one embodiment, the delays are weighted by an approximation of the number of misconnects that will result per minute of delay and the cancellations are weighted by a Course Deviation Indicator that is provided to the HEAT application 15. Constraint sets (2)-(7) relate to flight and crew flow constraints. Constraint sets (2) and (3) ensure that each flight has only one aircraft assigned or the flight is cancelled. Constraint set (4) ensures that “cancel in” equals “cancel out.” Constraint sets (5) and (6) ensure that each flight has crew assigned to position k. In some embodiments, the constraint set (5) does not include source flights and constraint set (6) does not include a sink node or cancellation node. Constraint set (7) relates to the maximum number of reserve crew. Generally, the objective function is subjected to flow constraints that ensures each flight uses exactly one aircraft and that crew is assigned for each needed position.

Constraint sets (8)-(12) are delay propagation constraints to ensure that an aircraft departure time should be equal or bigger than an arrival time of that aircraft, plus MOGT or turn-around time for crew, for each flight pair (i,j). Constraint set (8) relates to aircraft delay propagation. That is, for each flight pair (i,j), the arrival time of flight i plus the MOGT between flights i and j must be equal to or less than the departure time of flight j. Moreover, any delay of flight i must be accounted for as well, so that for each flight pair (i,j), the arrival time of flight i plus the MOGT between flights i and j plus any delay of flight i, must be equal to or less than the departure time of flight j plus the delay of flight j. Constraint set (9) relates to aircraft max delay. Constraint set (10) relates to crew delay propagation. Constraint set (10) and constraint set (11) relate to crew max delay. A mathematical equation relating to delay propagation is below:

$$Arvl time of flt . i \times {x}_{ij} + {MOGT}_{ij} + {Delay}_{i} \leq Depart . time of flt . j + {Delay}_{j} \qquad ( 25 )$$

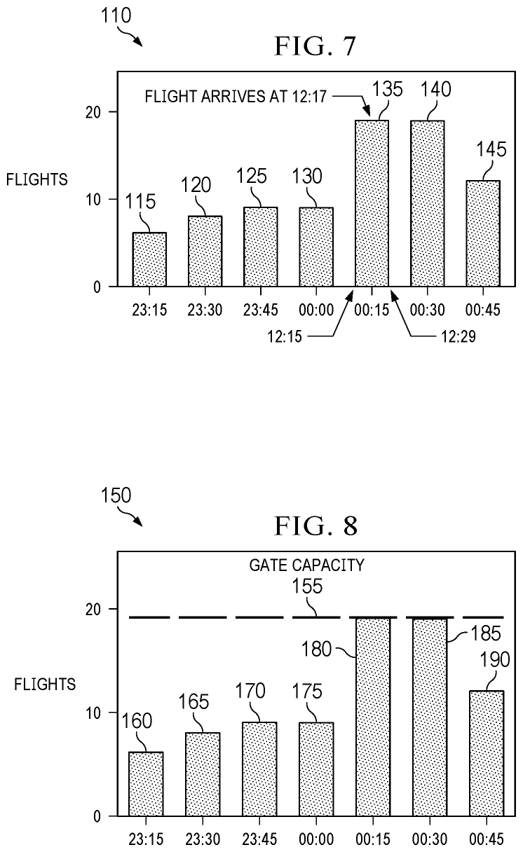

Constraint sets (13)-(17) are time bucket assignment constraints to ensure that each flight i departure time is within a start and end time of a time bucket; arrivals are similarly constrained but replacing departure buckets with arrival ones. Constraint set (13) and constraint set (14) ensure that aircraft arrive within a start and an end of a time bucket. Constraint set (15) and constraint set (16) ensure that aircraft depart within a start and an end of a time bucket. Constraint set (17) ensures that there is one time bucket per flight. FIG. 7 includes a chart 110 that illustrates multiple time buckets 115, 120, 125, 130, 135, 140, and 145 with the time bucket 135, which is associated with “00:15”, having a start time of 12:15 and an end time of 12:29. For each flight i departure time should be within a start and end time of time bucket. The mathematical equations below explain further.

$${\sum }_{t} Dep bucket t start time \times select dep bucket t \leq {Dep}_{i} + {Delay}_{i} \qquad ( 26 )$$

$${Dep}_{i} + {Delay}_{i} \leq {\sum }_{t} Dep bucket t end time \times select dep bucket t \qquad ( 27 )$$

$${\sum }_{t} select dep bucket t = 1 \qquad ( 28 )$$

Arrivals have the same constraints, but departure buckets are replaced with arrival ones.

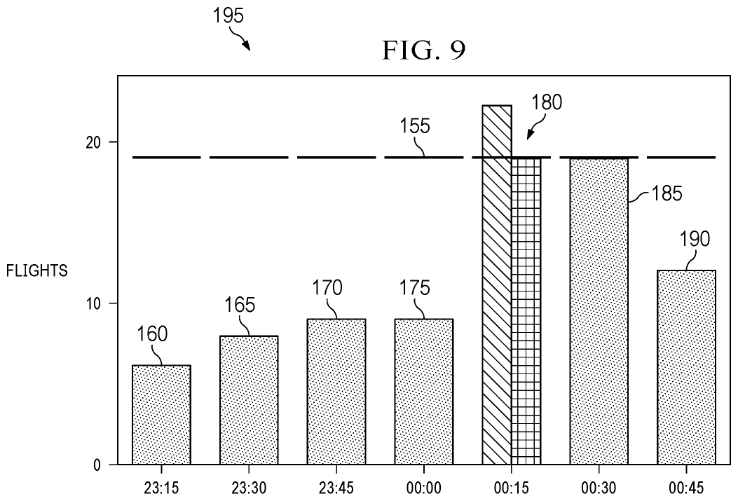

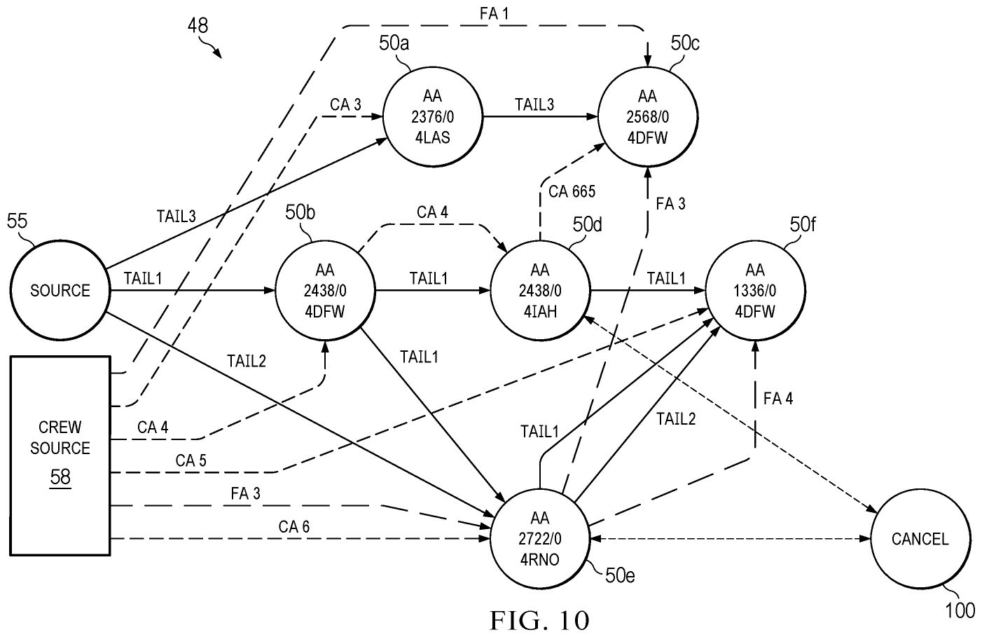

Constraint sets (18)-(20) are capacity constraints to ensure that the sum of flights in each time buckets is equal or less than the maximum capacity determined by the user. In some embodiments, constraint sets (18)-(20) are soft constraints with slack variables that are penalized in the objective function. Constraint set (18) relates to the arrival rate. Constraint set (19) relates to the departure rate. Constraint set (20) relates to gate capacity. FIG. 8 includes a chart 150 that illustrates a gate capacity indicator line 155 compared to initial gate demand across multiple time buckets 160, 165, 170, 175, 180, 185, and 190. As illustrated, the gate capacity is 19 and gate demand does not exceed gate capacity across each time bucket. FIG. 9 includes a chart 195 that illustrates a spike in gate demand beyond capacity within the time bucket 180, or time period “00:15.” This spike in gate demand for the time bucket t “00:15” or 180, which is associated with the time period of “00:15-00:30”, is divided further into “00:15-00:22” and “00:23-“00:29.” Four arrivals are expected in the “00:15-00:22” time period, which will exceed the gate capacity of 19 (with initial gate demand already at 19 as illustrated in FIG. 8 and then adding 4 more arrivals) but then, due to four departures within the time period of “00:23-“00:29”, the gate demand will be 19 for that time bucket t or 180. In some embodiments, the sum of arrivals and departures in bucket t should be equal or less than the maximum capacity of bucket t. The mathematical equations below explain further.

$$Gate demand at time bucket t = Initial gate demand + sum ( arrivals until time bucket t ) - sum ( departures until time bucket t ) \qquad ( 29 )$$

$$Gate demand at time bucket t = Initial gate demand + sum ( arrivals until time bucket t ) - sum ( departures before time bucket t ) \qquad ( 30 )$$

Constraint sets (21)-(24) are constraints to ensure balanced cancelations for each station, MaxCancelations, and swaps. Constraint set (21) balances cancelations for each station. That is, the sum of the “cancel in” equals to the sum of the “cancel out” for each station. Constraint set (22) ensures that the maximum cancelations are less than or equal to the max cancelations limit. Regarding the cancelations, generally excluded from cancellations (i.e., c_{i,e}=0) are flights that depart or arrive before a model start time, fleet exclusions, flights not included in the airline list, deadhead recovery, and flights that do not arrive or depart from the station list. Constraint set (23) and constraint set (24) ensure swaps are allowed only with a flight that is cancelled. Regarding the swap constraint, if flight i is assigned to be operated by tail l, which got cancelled, then a binary decision variable Dₗ, disrupted tail l, can be set to 1. The mathematical equation below explains further.

$${D}_{l} \leq {c}_{si} , for all cancel arc i assigned to be operated by tail l \qquad ( 31 )$$

Moreover, arc xᵢⱼ can only be 1 only if Dₗ is 1, thus flight i in cancelled. The mathematical equation below explains further.

$${x}_{ij} \leq {D}_{l} , for all arc i , j can be swap with tail l \qquad ( 32 )$$

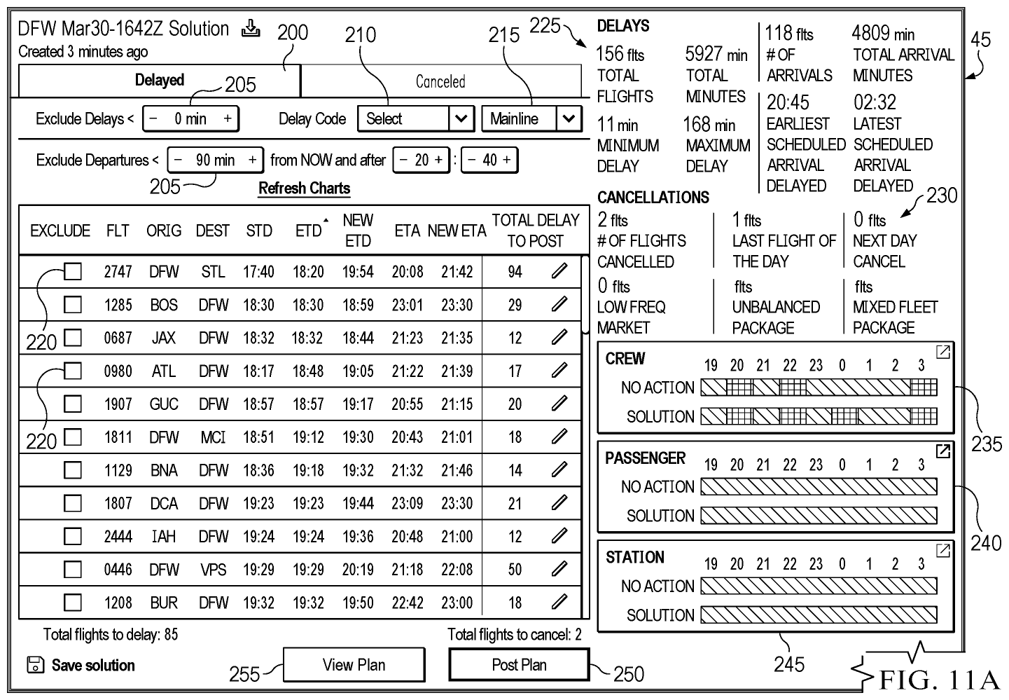

Using the mixed-integer program with weighted objectives to minimize delays, cancellations, capacity violations (e.g., Gate demand, Arrival Rate, Departure Rate), and extra crew usage, the HEAT application 15 identifies intentional delays and intentional cancellations of flights. FIG. 10 is a diagrammatic illustration of a portion of the network model 48 with flights represented as nodes 50a, 50b, 50c, 50d, 50e, and 50f, source node 55, crew source 58, and a cancel node 100. As illustrated, a plurality of flights has been identified for cancellation, such as the flights associated with the nodes 50d and 50e.

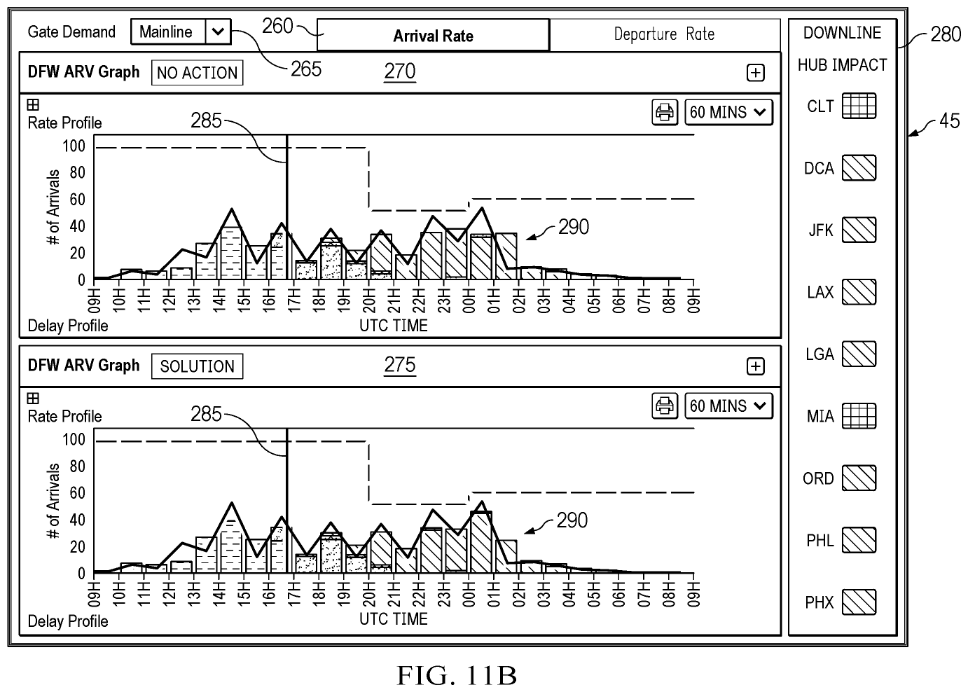

Before, during or after the step 70, the system 10 outputs the projected delays and cancellations at the step 75. In one embodiment, the system 10 can output the projected delays and cancellations associated with one station, a station of interest, or can output the projected delays associated with the transportation system. In one embodiment, the system 10 outputs the projected delays in the step 75 by displaying the parameters using the GUI 20a. FIGS. 11A and 11B together illustrate one example of the window 45 that displays a portion of a proposed solution or recommended management plan that comprises strategic travel leg delays for at least a portion of the travel legs and strategic travel leg cancellations for at least another portion of the travel legs. FIGS. 11A and 11B display only a portion of the recommended management plan. The recommended management plan also comprises crew assignments and aircraft assignments. That is, not only does the recommended management plan include recommended strategic travel leg delays and recommended strategic travel leg cancellations, but it also includes recommended crew and aircraft pairings for flights that are not recommended for cancellation. The recommended management plan includes, for a period of time defined by the start time and end time: a listing of flights, which includes non-cancelled and non-delayed flights, delayed flights, and cancelled flights; crew assignments for the non-cancelled and non-delayed flights and the delayed flights; and aircraft or tail assignments for the non-cancelled and non-delayed flights and the delayed flights; accordingly, the recommended management plan minimizes delays, cancellations, capacity violations, and extra crew usage. In one embodiment, the recommended management plan further comprises feasible crew assignments and feasible vehicle assignments for the strategically delayed travel legs and the travel legs for which neither the strategic travel leg delays nor the strategic travel leg cancellations are applicable. In one embodiment, the recommended management plan includes a feasible tail plan for the aircraft in that the aircraft assignments ensure that the MOGT requirements are met and the routing of aircrafts is maintained or preserved or at least changes to the routing is optimized to allow for maintenance and other considerations. In some embodiments, the window 45 displays a dashboard that includes a selectable toggle between “Delayed” and “Cancelled” flight listings via a selectable portion 200 or other graphical element. In some embodiments, the window 45 displays a selectable toggle, ticker, or other element 205 that allows for the user to instruct the HEAT application 15 to exclude from the display and/or exclude from the solution: delays that are less than a customizable period of time, departures that are less than a customizable period of time; and a time period from NOW to an entered time. In some embodiments, the window 45 displays a selectable toggle, ticker, drop down-menu or other elements 210 and 215 that allows for the user to instruct the HEAT application 15 to display flights associated with a selectable delay code and also display flights associated with either a mainland, or specific regional partner, respectively. Generally, regional partners provide crew data to the HEAT application 15 (up to half an hour delay) and the HEAT application 15 sends solutions for regional partners to review (e.g., exclude delay and cancellations and approve). In some embodiments, including the regional partners is an improvement over existing systems as it ensures fairness across wholly owned and non-wholly owned regional partners, especially regarding flight cancellations. As illustrated in FIGS. 11A and 11B, and based on the inputs provided via the elements 200, 205, 210, and 215, there are a total of two flights to cancel and 85 flights to delay. In the listing of proposed delayed flights, the window 45 includes selectable elements 220 that allows a user to exclude the flight from being delay and/or from being displayed in the listing. For each flight, the flight number, ORIG, DEST, STD, ETD, new ETD, ETA, NEW ETA, and Total Delay to Post data is displayed. The window 45 may also include a summary delay portion 225 that includes the total number of delayed flights, total delayed minutes, minimum delay, maximum delay, total number of flight arrivals, total arrival minutes, earliest scheduled arrival delay, and latest scheduled arrival delay. The window 45 may also include a summary cancellation portion 230 that includes the total number of cancelled flights, number of flights cancelled in low frequency markets, number of cancelled flights that is a last flight of the day to a destination airport, number of flights that are an unbalanced package, number of cancelled next day flights, and number of cancelled mixed fleet packages. The window 45 may also include a summary crew portion 235, a summary passenger portion 240, and a summary station portion 245, which each providing additional details. The window 45 may also include selectable buttons 250 and 255, which instructs the HEAT application 15 to post the plan and view the plan, respectively. In some embodiments, posting the plan is effectively cancelling the flights and delaying the flights. In some embodiments, the window 45 displays a selectable toggle 260 or other graphical element between “Arrival Rate” and “Departure Rate” listings, and a dropdown menu 265 or other selectable or input element that allows for the user to instruct the HEAT application 15 to display gate demand sorted by mainline, regional, or other entity or selectable option. When “Arrival Rate” is selected, as illustrated in FIG. 11B, the window 45 may also include a chart or graph 270 and 275, with graph 270 showing the number of arrivals over time associated with DFW “NO ACTION” and graph 275 showing the number of arrival over time associated with DFW “SOLUTION.” In some embodiments, the graph 270 depicts the delays if the proposed solution is not implemented and the graph 275 depicts the delay if the proposed solution is implemented. The window 45 also includes a downline hub impact portion 280 that provides a visual indicator to indicate which, if any, downline hubs are impacted. Regarding charts displayed using the HEAT application 15, such as the graph 270 and 275, a vertical line 285 represents the current time and where the current time is compared to a plurality of vertical bars 290 that are associated with the time buckets and the height of which represent the value of the number of arrivals (or other measured and displayed value). As illustrated, the time period to the right of the vertical line 285 represents a future period of time and the time period to the left of the vertical line 285 represents the past.

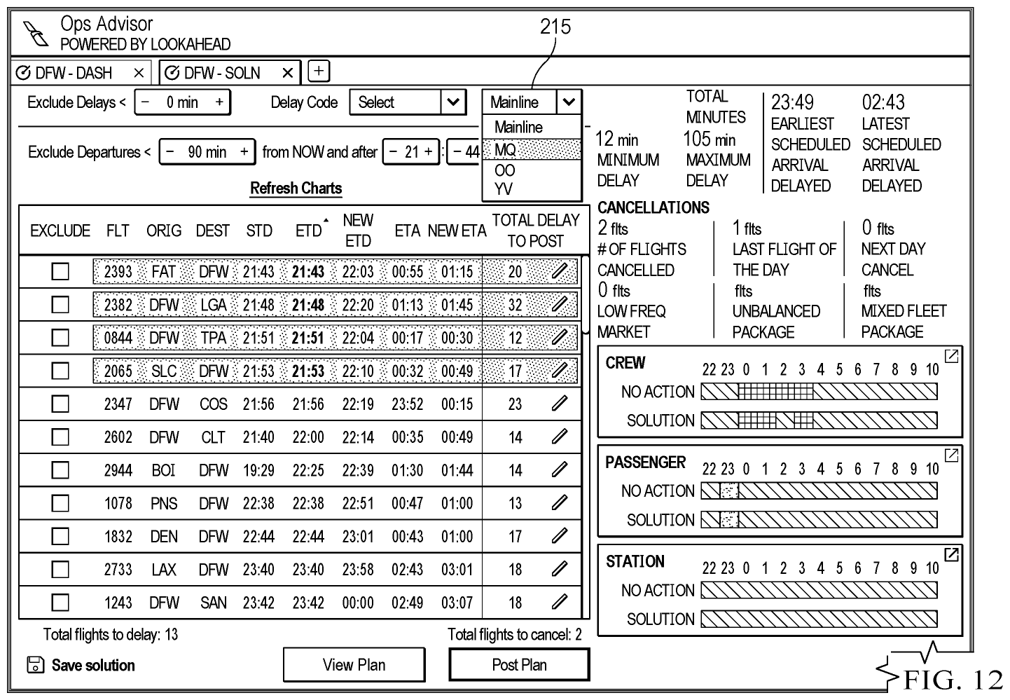

FIG. 12 is one example of the window 45 that displays a portion of proposed solution and is identical to FIG. 11B except that the dropdown menu 215 is expanded to display the selectable regional partners so that the display can be updated to view the cancellations and delays associated with that partner/airline.

After reviewing the projected delays from the step 75, a user may be able to identify and respond to an ongoing or anticipated disruption at an airport or station of interest. In one embodiment, once it is determined by the system 10 that a response is required, the system 10 may develop the proposed solution, as shown in FIGS. 11A and 11B. In one embodiment, the user selecting the button 250, for posting the plan, instructs the HEAT application 15 to implement the delays and cancellations as well as publish these delays and cancellations.

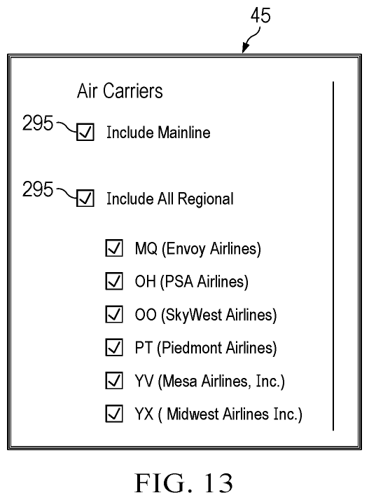

One of the improvements in the technical field of disruption management during IROPs that is associated with the HEAT application 15 is a result of the user interface. FIG. 13 illustrates a portion of the user interface of the HEAT application 15, which forms a portion of the window 45. As illustrated in FIG. 13, the user interface of the HEAT application 15 provides selectable buttons 295 or other input elements to allow for the user to input or select the different air carriers to include in the solution.

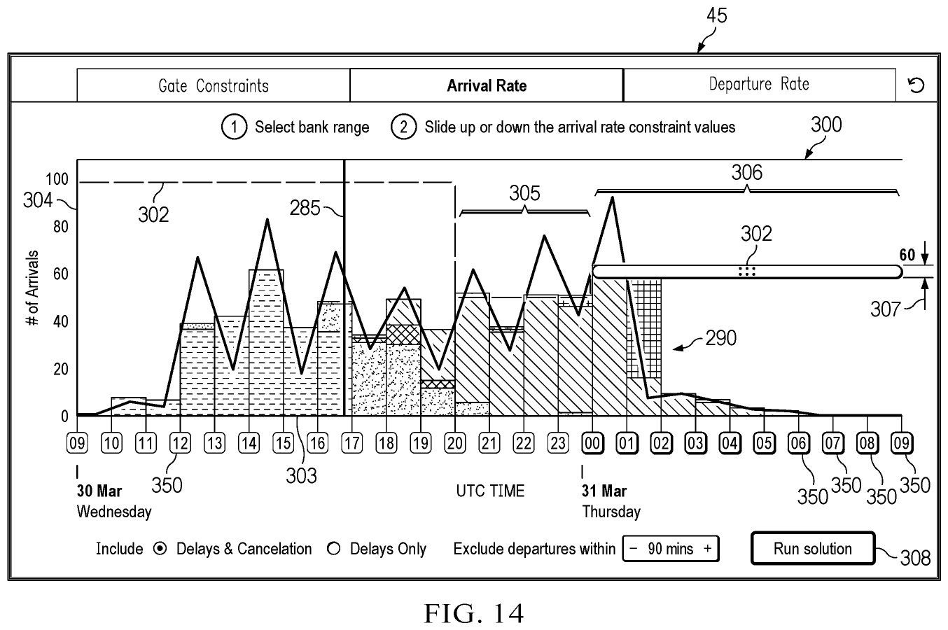

Another example of the improved user interface is illustrated in FIG. 14. FIG. 14 depicts the window 45 that includes a chart 300 that is similar to the charts 270 and 275. The numerals 285 and 290 in FIG. 14 represent the same elements as the numerals 285 and 290 in FIG. 11B. A line 302 is displayed over the chart 300, with the line 302—extending parallel to a time axis 303—positioned perpendicular to an arrival axis 304. In some embodiments, the line 302 represents an arrival rate constraint value and/or arrival capacity. The location of the line 302 relative to the time axis 303 varies over time. In some embodiments, the line 302 can be divided into bank ranges, such as for example bank ranges 305 and 306. Other bank ranges are contemplated here and can be selected in increments of time that correspond with the increments of time represented by each bar in the plurality of bars 290 representing the number of arrivals. In some embodiments, the line 302 is selectable by a user, and a bank range, such as the bank range 306, can be selected by the user. In some embodiments, the line 302 associated with the selected bank range can be slid up or down to change the arrival rate constraint value(s). In some embodiments, the line 302 defines a thickness 307 and the thickness 307 of the line 302 is associated with a value of the arrival rate constraint value used in the constraint set (18). In some embodiments, the thickness 307 of the line 302 can be increased (decreased) by sliding the line away from (toward) the time axis to indicate that arrival rate constraint value considered by the mixed-integer program should be updated or changed. In some embodiments, changing the thickness or thickness dimension of the line 302 is changing the positioning of the line 302 relative to the chart 300. As such, in the example illustrated in FIG. 14, the line 302 is a selectable graphical element that is also adjustable. Changing the arrival rate constraint values via the element 302 alters the constraint throughout the model when determining the solution. The window 45 also includes a “run solution” button 308 or other input that is selectable by the user to provide instructions to the system 10 to create a new solution using the updated or changed arrival rate constraint value. In some embodiments, the arrival rate constraint value accounts for delays in arrival rates. When the run solution 308 button is selected, the HEAT application 15 calculates updated values for the projected demand over the future period of time, using the updated constraint value associated with a change in position of the 302, and then updates the chart 300 using the updated values for projected demand over the future period of time.

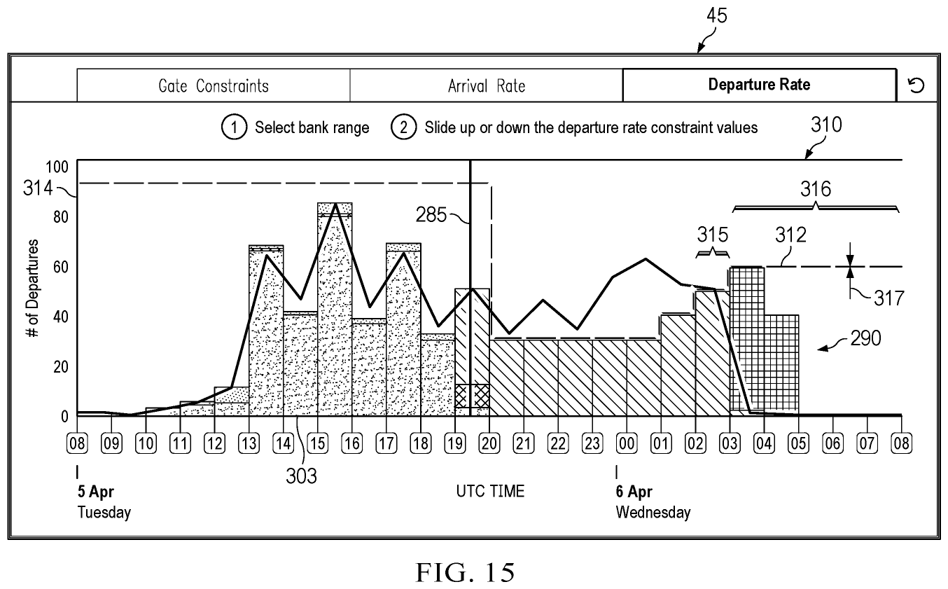

FIG. 15 depicts the window 45 that includes a chart 310 that is similar to the chart 300 except that the chart 310 is associated with departures. A line 312 is displayed over the chart 310, with the line 312—extending parallel to the time axis 303—positioned perpendicular to a departure axis 314. In some embodiments, the line 312 represents a departure rate constraint value and/or a departure capacity. The location of the line 312 relative to the time axis 303 varies over time. In some embodiments, the line 312 can be divided into bank ranges, such as for example bank ranges 315 and 316. Other bank ranges are contemplated here and can be selected in increments of time that correspond with the increments of time represented by each bar in the plurality of bars 290, shown in FIG. 15 representing the number of arrivals. In some embodiments, the line 312 is selectable by a user such as the bank range is selected by a user. In some embodiments, the line 312 associated with the selected bank range can be slid up or down to change the departure rate constraint value(s). In some embodiments, the line 312 defines a thickness 317 and the thickness 317 of the line 312 is associated with a value of the departure rate constraint value used in the constraint set (19). In some embodiments, the thickness 317 of the line 312 can be increased (decreased) by sliding the line away from (toward) the time axis 303 to indicate that the departure rate constraint value considered by the mixed-integer program should be updated or changed. In some embodiments, the departure rate constraint value accounts for delays or changes in departure rates. One example involving the departure rate constraint values changing relates to deicing processes, which reduces the number flights to depart from an airport since additional time needs to be added to the departure process. Changing the departure rate constraint values via the element 312 alters the constraint throughout the model when determining the solution.

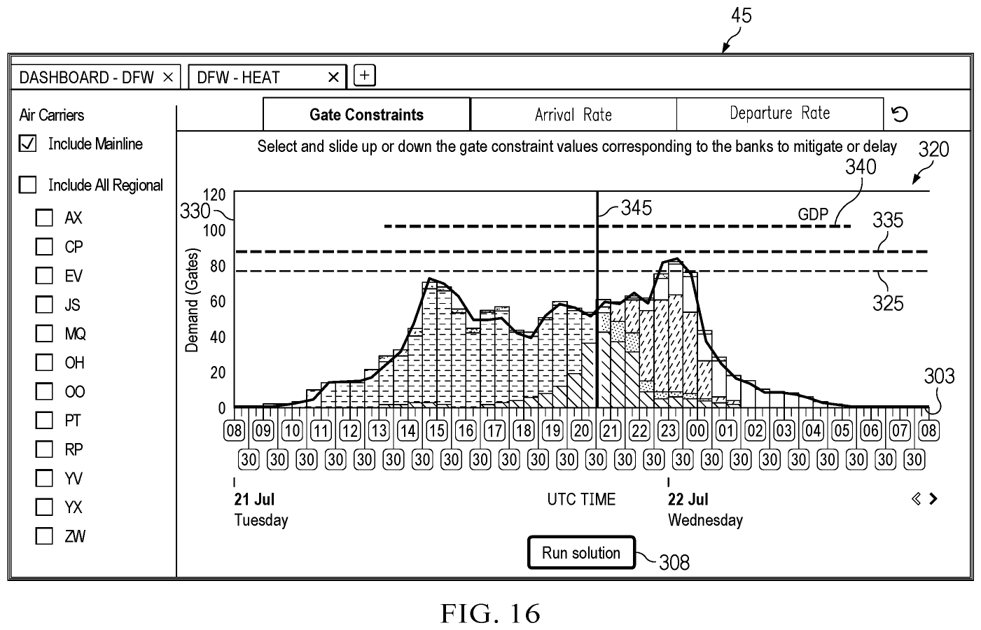

FIG. 16 depicts the window 45 that includes a chart 320 depicting gate demand and capacity over a period of time. The chart 320 includes a first line 325—extending parallel to the time axis 303—positioned perpendicular to the gate demand axis 330 at a position representing a I number of gates that are available. A second line 335 and a third line are displayed over the chart 320. The second line 335—extending parallel to the time axis 303 and the first line 325—is positioned perpendicular to the demand axis 330 at a position representing a threshold gate demand value associated with implementing a first type of delay. The third line 340—extending parallel to the time axis 303 and the first line 325—is positioned perpendicular to the demand axis 330 at a position representing a threshold gate demand value associated with implementing a second type of delay. The chart 320 also includes a fourth line 345—extending parallel to the demand axis 330—positioned perpendicular to the time axis 303 at a position representing the current time. In some embodiments, the first type of delay is a ground stop delay and the second type of delay is a ground delay program. In some embodiments, the lines 335 and 340 are selectable and moveable along the demand axis 330. That is, changing the position of the line 335 and/or 340 changes the input or parameters used in the mixed-integer program that is calculating a solution. As such, each of the lines 335 and 340 is a selectable graphical element that adjusts, by being moved along the demand axis 330, the value of the constraint associated with the threshold gate demand value. The window 45 also includes the selectable button 308 that instructs the system 10 to calculate a solution using the updated or revised parameters associated with the first and second types of delay. The ability for the lines 335 and 340 to be drug and dropped to alter the threshold demand value, which if exceeded result in a ground stop and/or a ground delay program, allows for the user to dynamically update parameters used by the HEAT application 15.

As illustrated in FIGS. 14-16, the window 45 provides a visual depiction of both the demand of a variable (e.g., gate, arrival, departure) and the associated capacity over a period of time, as well as a visual depiction of a constraint value.

Generally, the ability of a user to grab, drag, and/or otherwise move a graphic element displayed on the window 45 to update constraint values and/or soft constraints with slack variables that are penalized in the objective function is an improvement to the technical field of disruption management during IROPs. That is, the window 45 does not merely display data to a user. Instead, the window 45 provides a visual depiction of both the demand and the capacity, as well as a visual depiction of a constraint value. For example, the ability for the lines 335 and 340 to be drug and dropped to alter the threshold gate demand value, which if exceeded results in a ground stop and/or a ground delay program, allows for the user to dynamically update parameters used by the HEAT application 15. The ability to grab, drag, and/or otherwise move a graphic element displayed on the window 45 to update constraints has no pre-electronic analog and results in improvements relating to speed, accuracy, and usability of the HEAT application 15 and/or of any system that handles disruption management during IROPs. As such, the ability of a user to grab, drag, and/or otherwise move a graphic element displayed on the window 45 to update constraint values in the objective function is an improvement to the technical field of disruption management during IROPs.

The elements 302, 312, 335, and 340 are examples of elements displayed in the user interface via the window 45 that allow for user(s) to directly interact with gate demand, departure charts, and arrival charts and constraints associated with each. In some embodiments, other graphical elements illustrated in the charts 270, 275, 300, 310, and 320 have units on the time axis that have large clickable areas for a user to interact with. For example, the HEAT application 15 displays a user interface that receives instructions from a user regarding the start and end time using clickable or selectable buttons or other elements. For example and returning back to FIG. 14, in some embodiments, the time axis 303 includes units 350 of time. These units of time 350 are selectable and draggable to edit the period of time viewable on the time axis 303 and/or used as the start and end time for the mixed-integer program. In some embodiments, the unit of time “08” associated with March 31 can be selected and moved away from the “current time” line 285 and/or the demand axis 304 to shorten the period of time viewable on the time axis 303 or moved toward the “current time” line 285 and/or the demand axis 304 to lengthen the period of time viewable on the time axis 303. Similarly, the unit of time “11” associated with March 30 can be moved toward the “current time” line 285 and away from the demand axis 304 to lengthen the period of time viewable on the time axis 303 or be moved away from the “current time” line 285 and toward the demand axis 304 to shorten the period of time viewable on the time axis 303. In some embodiments, the period of time viewable on the time axis 303 corresponds to a start time and end time for the model and changing the period of time viewable on the time axis 303 provides the start and end time considered by the mixed-integer program. There are other examples in which the HEAT application 15 displays a user interface that includes drag controls that appear corresponding to the start and end times selected. For example, the HEAT application 15 displays a user interface that includes colors for the selected time range that match that of the dragger for easy association. For example, the HEAT application 15 displays a user interface that allows a user to increase or decrease the range covered by the dragger using the time axis. For example, the HEAT application 15 displays a user interface that, once a time range is selected, users can move the dragger to a target value for Gate Demand, number of Arrivals or Departures. For example and returning back to FIGS. 8 and 9, the line 155 is selectable and draggable to edit the value of the gate capacity. In one embodiment, the HEAT application 15 displays a user interface that, as a dragger is moved, the real-time value of the gate demand, arrivals, or departures is displayed next to it (and moves with it). Returning back to FIG. 14, the numeral 60 is displayed next to the line 305 in bank range 306. As illustrated at least in FIGS. 11A, 11B, and 12-16, the HEAT application 15 displays a user interface that provides instant visualization of flight distribution across adjacent time banks.

Another improvement of the HEAT application 15 is associated with complying with regulatory business plans and goals. For example, and in some embodiments, the HEAT application 15 provides a minimum viable product 1 or MVP 1 related to the demonstration of the visualization, analytics, and dashboards for efficiency reporting. One example is chart 310 of FIG. 15 and the display of runway time, or “on” time versus gate time or “in” time using color blocking (illustrated as different graphical symbols in FIG. 15).

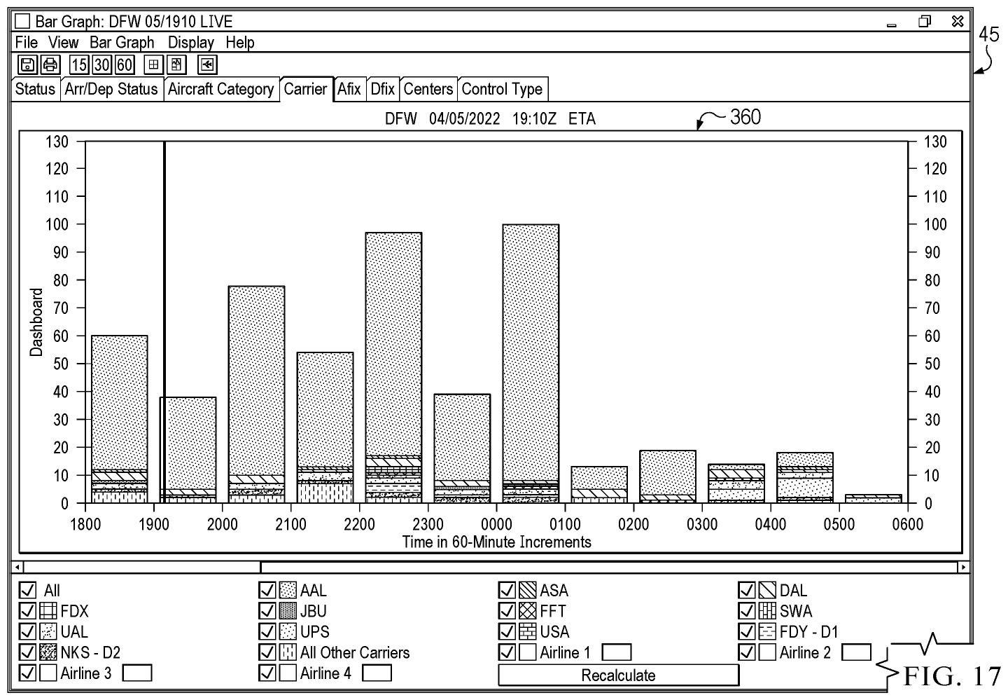

Another improvement of the HEAT application 15 is associated with complying with regulatory business plans and goals. For example, and in some embodiments, the HEAT application 15 includes other airlines flights to model and/or match airport arrival demand, as set forth by the FAA. For example, and in some embodiments, the HEAT application 15 delays and cancels AA mainline and regional flights only. FIG. 17 illustrates the window 45 that includes a chart 360, which provides a graphical display that includes other airlines flights to model and/or match airport arrival demand, as set forth by the FAA.

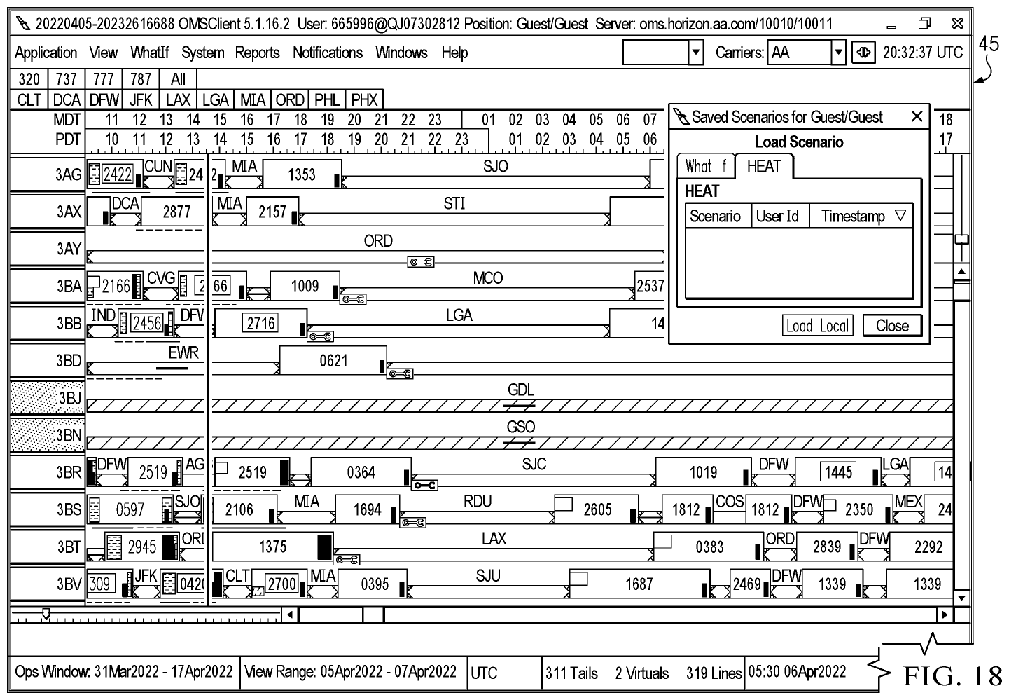

Another improvement of the HEAT application 15 is associated with exporting the HEAT solution to the Operations Management System (OMS) as a what-if for verification. FIG. 18 illustrates the window 45 that is associated with exporting the HEAT solution to OMS as a what-if for verification.

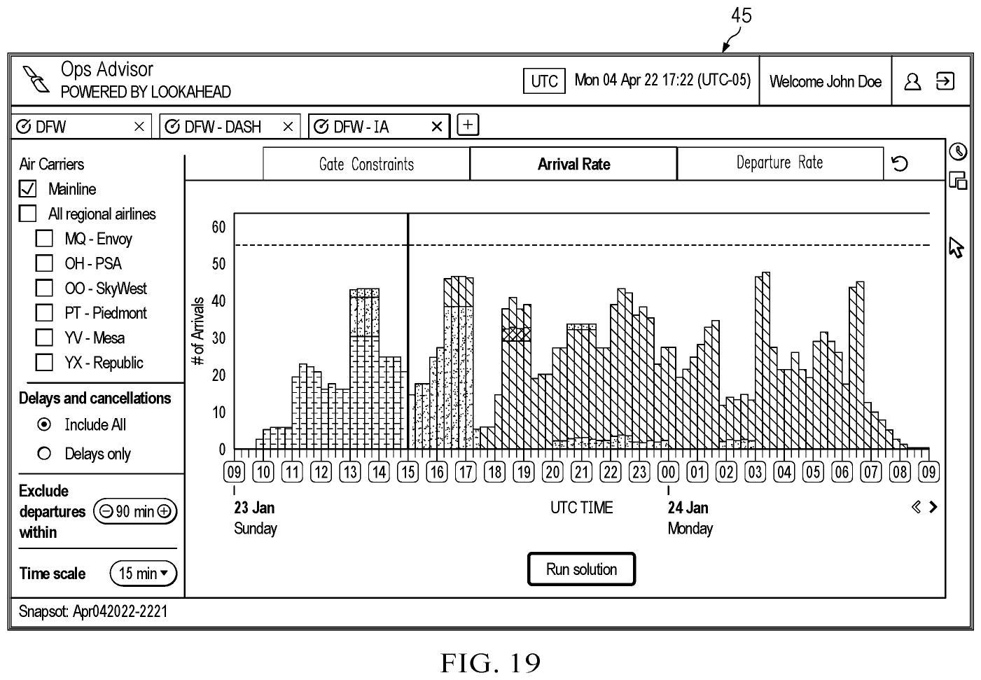

Another improvement of the HEAT application 15 is associated with displaying a time scale chart display that syncs with federal regulations and/or regulating agencies. FIG. 19 illustrates the window 45 that is associated with displaying a time scale chart display that syncs with federal regulations and/or regulating agencies.

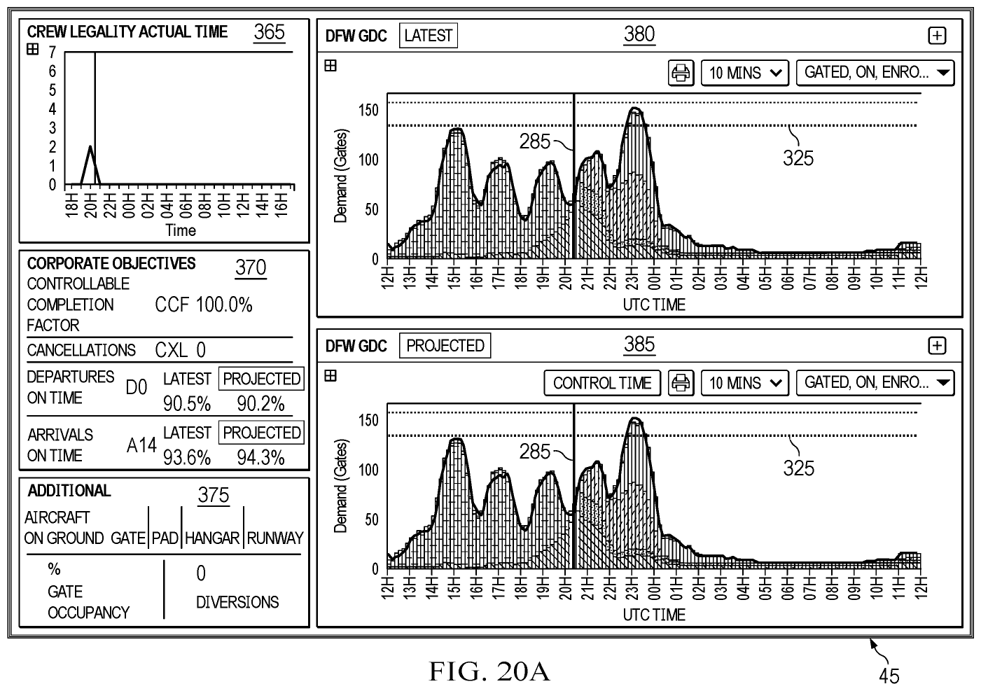

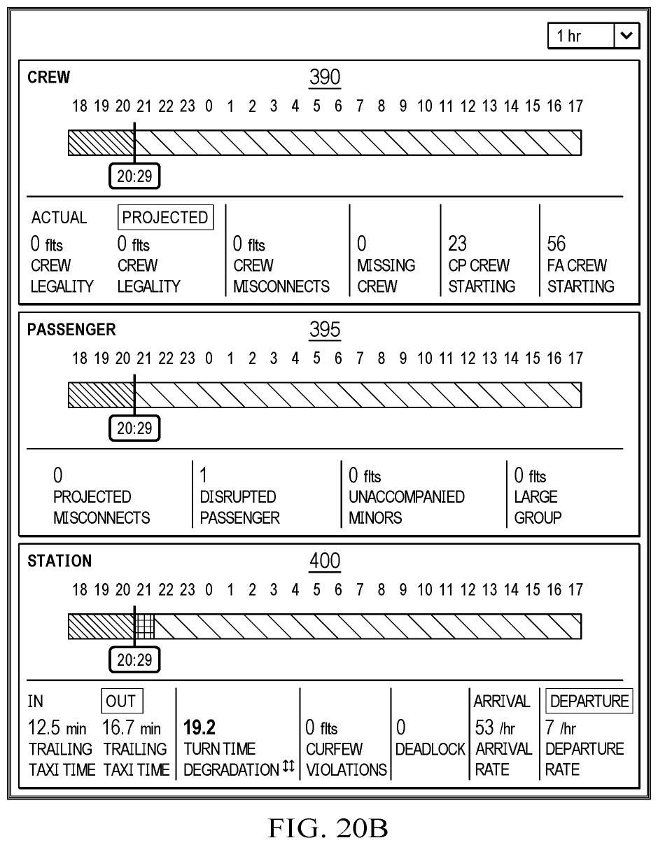

In some embodiments, the HEAT application 15 monitors for operational irregularities, such as long gate or taxi delays, crew duty and/or layover violations, airport curfew violations, gate congestion, and/or passenger misconnects. FIGS. 20A and 20B together form the window 45 when the HEAT application 15 is displaying a user interface associated with monitoring for IROPs. The window 45 illustrated in FIGS. 20A and 20B includes a chart 365 relating to crew legality actual time, a portion 370 that summarizes corporate objectives, a portion 375 relating to additional data, a portion and chart 380 relating to a latest station gate demand chart, a chart 385 relating to projected station gate demand chart, a portion 390 relating to crew data, a portion 395 relating to passenger data, and a portion 400 relating to station data. The system 10 can monitor not only one airport or station, but can monitor an entire transportation system, which includes a plurality of stations.

The HEAT application 15, and the improvements noted above, is estimated to reduce cancellations by 10% over existing systems, which may result in at least approximately $6.8M saved annually. In some embodiments, the contribution of regional crew data and departure rate enhancements, with reginal crew data is estimated to result in 3% reduction in number of cancellations, which could result in at least approximately $1.3M saved annually. In some embodiments, the HEAT application 15 reduces deicing cancellations by approximately 10%, which could result in at least approximately $660K saved annually.

In some embodiments, the HEAT application 15 is capable of considering multiple situations and scenarios, including deicing, diversion prevention, diversion recovery, exit from GS (“Ground Stops”)/GDP (“Ground Delay Program”), implement company GDP, and ramp closures. In some embodiments, the HEAT application 15 can be used to be proactive in detecting and responding to IROPs. In some embodiments, the HEAT application 15 also accounts for over-night crew rest time, considers airport curfew in a solution, and/or limits reserve crew based on actual number of reserve crew available. In some embodiments, a ground stop or ground stop delay is associated with a delay implemented by ground control whereas a ground delay program is associated with more extensive delays that are implemented by an airline.

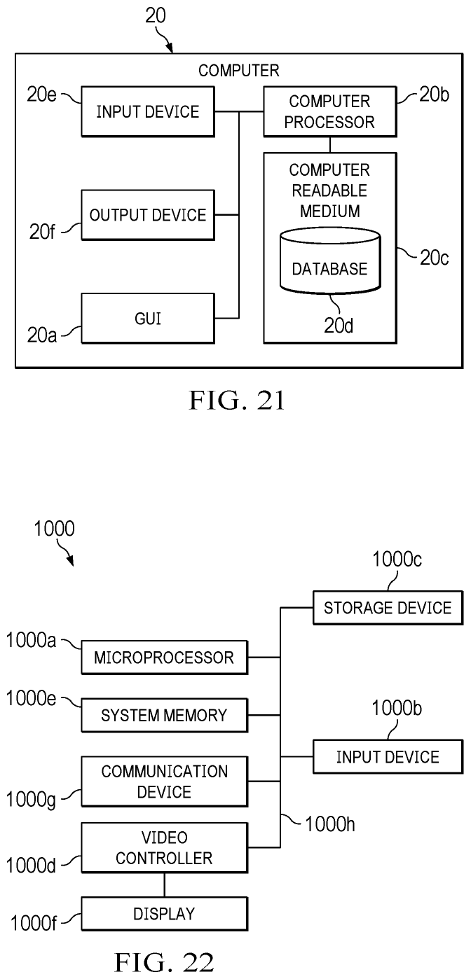

In an example embodiment, as illustrated in FIG. 21 with continuing reference to FIG. 1, the computer 20 includes a GUI 20a, computer processor 20b and a computer readable medium 20c operably coupled thereto. Instructions accessible to, and executable by, the computer processor 20b are stored on the computer readable medium 20c. A database 20d is also stored in the computer readable medium 20c. Generally, the GUI 20a can display a plurality of windows, such as the window 45, or screens to the user. The computer 20 also includes an input device 20e and an output device 20f. In some embodiments, the input device 20e and the output device 20f are the GUI 20a. In some embodiments, the user provides inputs to the system 10 via a window such as the window 45 that is displayed on the GUI 20a. However, the input device 20e can also be a microphone in some embodiments and the output device 20f is a speaker. In several example embodiments, the computer 20 is, or includes, a telephone, a personal computer, a personal digital assistant, a cellular telephone or mobile phone, other types of telecommunications devices, other types of computing devices, and/or any combination thereof. In several example embodiments, the computer 20 includes a plurality of remote user devices. While only one computer 20 is illustrated in FIG. 1, the system 10 generally includes a plurality of computers. For example, in some embodiments the computer 20 is a remote user device and a user is associated with the remote user device. In some embodiments, and when the computer 20 is a remote user device, the application 15 displays a mobile application on the GUI 20a and when the computer 20 is a desktop computer, the application 15 displays a desktop application on the GUI 20a.

In an example embodiment, as illustrated in FIG. 22 with continuing reference to FIGS. 1-10, 11A, 11B, 12-19, 20A, 20B, and 21, an illustrative computing device 1000 for implementing one or more embodiments of one or more of the above-described networks, elements, methods and/or steps, and/or any combination thereof, is depicted. The computing device 1000 includes a processor 1000a, an input device 1000b, a storage device 1000c, a video controller 1000d, a system memory 1000e, a display 1000f, and a communication device 1000g, all of which are interconnected by one or more buses 1000h. In several example embodiments, the storage device 1000c may include any form of computer readable medium that may contain executable instructions. In several example embodiments, the communication device 1000g may include a modem, network card, or any other device to enable the computing device 1000 to communicate with other computing devices. In several example embodiments, any computing device represents a plurality of interconnected computer systems.

In several example embodiments, one or more of the computer 20, the computer processor 20b, the computer readable medium 20c, the database 20d, and/or one or more components thereof, are, or at least include, the computing device 1000 and/or components thereof, and/or one or more computing devices that are substantially similar to the computing device 1000 and/or components thereof. In several example embodiments, one or more of the above-described components of one or more of the computing device 1000, the computer 20, the computer processor 20b, the computer readable medium 20c, the database 20d, and/or one or more components thereof, include respective pluralities of same components.

In several example embodiments, a computer system typically includes at least hardware capable of executing machine readable instructions, as well as the software for executing acts (typically machine-readable instructions) that produce a desired result. In several example embodiments, a computer system may include hybrids of hardware and software, as well as computer sub-systems.

In several example embodiments, hardware generally includes at least processor-capable platforms, such as client-machines (also known as personal computers or servers), and hand-held processing devices (such as smart phones, tablet computers, personal digital assistants (PDAs), or personal computing devices (PCDs), for example). In several example embodiments, hardware may include any physical device that is capable of storing machine-readable instructions, such as memory or other data storage devices. In several example embodiments, other forms of hardware include hardware sub-systems, including transfer devices such as modems, modem cards, ports, and port cards, for example.

In several example embodiments, software includes any machine code stored in any memory medium, such as RAM or ROM, and machine code stored on other devices. In several example embodiments, software may include source or object code. In several example embodiments, software encompasses any set of instructions capable of being executed on a computing device such as, for example, on a client machine or server.

In several example embodiments, combinations of software and hardware could also be used for providing enhanced functionality and performance for certain embodiments of the present disclosure. In an example embodiment, software functions may be directly manufactured into a silicon chip. Accordingly, it should be understood that combinations of hardware and software are also included within the definition of a computer system and are thus envisioned by the present disclosure as possible equivalent structures and equivalent methods.

In several example embodiments, computer readable mediums include, for example, passive data storage, such as a random access memory (RAM) as well as semi-permanent data storage such as a compact disk read only memory (CD-ROM). One or more example embodiments of the present disclosure may be embodied in the RAM of a computer to transform a standard computer into a new specific computing machine. In several example embodiments, data structures are defined organizations of data that may enable an embodiment of the present disclosure. In an example embodiment, a data structure may provide an organization of data, or an organization of executable code.

In several example embodiments, the network 32, and/or one or more portions thereof, may be designed to work on any specific architecture. In an example embodiment, one or more portions of the network 32 may be executed on a single computer, local area networks, client-server networks, wide area networks, internets, hand-held and other portable and wireless devices and networks.

In several example embodiments, a database may be any standard or proprietary database software. In several example embodiments, the database may have fields, records, data, and other database elements that may be associated through database specific software. In several example embodiments, data may be mapped. In several example embodiments, mapping is the process of associating one data entry with another data entry. In an example embodiment, the data contained in the location of a character file can be mapped to a field in a second table. In several example embodiments, the physical location of the database is not limiting, and the database may be distributed. In an example embodiment, the database may exist remotely from the server, and run on a separate platform. In an example embodiment, the database may be accessible across the Internet. In several example embodiments, more than one database may be implemented.

In several example embodiments, a computer program, such as a plurality of instructions stored on a computer readable medium, such as the computer readable medium 20c, the system memory 1000e, and/or any combination thereof, may be executed by a processor to cause the processor to carry out or implement in whole or in part the operation of the system 10, the method 60, and/or any combination thereof. In several example embodiments, such a processor may include one or more of the computer processor 20b, the processor 1000a, and/or any combination thereof. In several example embodiments, such a processor may execute the plurality of instructions in connection with a virtual computer system.

In an example embodiment, the system 10 includes a computer program including a plurality of instructions, data, and/or any combination thereof. In an example embodiment, the HEAT application 15 is an application written in, for example, HyperText Markup Language (HTML), Cascading Style Sheets (CSS), JavaScript, Extensible Markup Language (XML), asynchronous Javascript and XML (Ajax), and/or any combination thereof. In an example embodiment, the HEAT application 15 is a web-based application written in, for example, Java or Adobe Flex, which pulls real-time information from the computer 20 and/or the plurality of data sources 25. In an example embodiment, the HEAT application 15 pulls real-time information from the computer 20 and/or the plurality of data sources 25, upon the execution, opening or start-up of the HEAT application 15. In an example embodiment, the HEAT application 15 is a web-based application written in, for example, Java or Adobe Flex, which pulls real-time information from the computer 20 and/or the plurality of data sources 25, automatically refreshing with latest information every, for example, 45 seconds.

The present disclosure provides an apparatus including a non-transitory computer readable medium; and a plurality of instructions stored on the non-transitory computer readable medium and executable by one or more processors, the plurality of instructions including instructions that cause the one or more processors to implement the method 60.

The present disclosure also provides a method including: displaying, on a user interface, a graphical depiction of projected demand over a future period of time; wherein values of the projected demand are calculated using a constraint; displaying, on the user interface and over the graphical depiction, a selectable graphical element; wherein at least a portion of the selectable graphical element is displayed at a first position associated with a first value of the constraint; and wherein the at least a portion of the selectable graphical element is adjustable, relative to the graphical depiction and by a user, to change the value of the constraint; receiving, via the user interface, an indication that the at least a portion of the selectable graphical element has been adjusted from the first position to a second position associated with a second value of the constraint; calculating updated values of the projected demand over the future period of time using the second value of the constraint; and updating the graphical depiction using the updated values for projected demand over the future period of time. In one embodiment, the projected demand is a number of flight arrivals and the constraint is an arrival rate constraint; the projected demand is a number of flight departures and the constraint is a departure rate constraint; or the projected demand is a gate demand and the constraint is a threshold gate demand value which, when exceeded by the gate demand, results in a type of flight delay. In one embodiment, the graphical depiction is a bar chart including: a time axis; a demand axis; and a plurality of bars representing the projected demand over the future period of time, wherein a width of each bar of the plurality of bars-along the time axis-represents a time period within the future period of time, and a height of each bar of the plurality of bars-along the demand axis that is perpendicular to the time axis-represents a total projected demand in that time period. In one embodiment, the selectable graphical element is a line extending parallel with the time axis and perpendicular to the demand axis; and wherein the at least a portion of the selectable graphical element is adjusted by moving the line, relative to the graphical depiction and along the demand axis, to change the value of the constraint. In one embodiment, the selectable graphical element is a line extending parallel with the time axis and perpendicular to the demand axis; wherein the line defines a thickness dimension measured along the demand axis; and wherein the at least a portion of the selectable graphical element is adjusted by changing the thickness dimension of the line to change the value of the constraint.

The present disclosure also provides a system including a non-transitory computer readable medium having stored thereon a plurality of instructions, wherein the instructions are executed with one or more processors so that the following steps are executed: displaying, on a user interface, a graphical depiction of projected demand over a future period of time; wherein values of the projected demand are calculated using a constraint; displaying, on the user interface and over the graphical depiction, a selectable graphical element; wherein at least a portion of the selectable graphical element is displayed at a first position associated with a first value of the constraint; and wherein the at least a portion of the selectable graphical element is adjustable, relative to the graphical depiction and by a user, to change the value of the constraint; receiving, via the user interface, an indication that the at least a portion of the selectable graphical element has been adjusted from the first position to a second position associated with a second value of the constraint; calculating updated values of the projected demand over the future period of time using the second value of the constraint; and updating the graphical depiction using the updated values for projected demand over the future period of time. In one embodiment, the projected demand is a number of flight arrivals and the constraint is an arrival rate constraint; the projected demand is a number of flight departures and the constraint is a departure rate constraint; or the projected demand is a gate demand and the constraint is a threshold gate demand value which, when exceeded by the gate demand, results in a type of flight delay. In one embodiment, the graphical depiction is a bar chart including: a time axis; a demand axis; and a plurality of bars representing the projected demand over the future period of time, wherein a width of each bar of the plurality of bars—along the time axis—represents a time period within the future period of time, and a height of each bar of the plurality of bars—along the demand axis that is perpendicular to the time axis—represents a total projected demand in that time period. In one embodiment, the selectable graphical element is a line extending parallel with the time axis and perpendicular to the demand axis; and wherein the at least a portion of the selectable graphical element is adjusted by moving the line, relative to the graphical depiction and along the demand axis, to change the value of the constraint. In one embodiment, the selectable graphical element is a line extending parallel with the time axis and perpendicular to the demand axis; wherein the line defines a thickness dimension measured along the demand axis; and wherein the at least a portion of the selectable graphical element is adjusted by changing the thickness dimension of the line to change the value of the constraint.

The present disclosure also provides a method including: receiving, using a computer, transportation-related data associated with a plurality of travel legs; wherein each travel leg in the plurality of travel legs is associated with a departure station and a destination station; and wherein the transportation-related data includes: travel leg data for each travel leg in the plurality of travel legs; and crew data for each travel leg in the plurality of travel legs; identifying, using the computer, a disruption to operations of the plurality of travel legs; generating, using the computer and based on the transportation-related data, a network model; identifying, based on the transportation-related data and using the network model, a recommended management plan for the identified disruption, wherein the recommended management plan includes strategic travel leg delays for at least a portion of the travel legs and strategic travel leg cancellations for at least another portion of the travel legs; and wherein identifying the strategic travel leg delays and strategic travel leg cancellations includes: weighting a potential delay of a travel leg by an approximation of a number of misconnects that will result per time period of the potential delay; weighting, using slack variables, a potential delay of a travel leg and/or a potential cancellation of a travel leg to account for capacity constraints; and minimizing a sum of weighted potential delays plus a sum of weighted potential cancellations plus capacity violations; and outputting, on a user interface of the computer, at least a portion of the recommended management plan that includes the strategic travel leg delays for at least a portion of the travel legs and the strategic travel leg cancellations for at least another portion of the travel legs. In one embodiment, the network model includes: a plurality of travel leg nodes, wherein each travel leg of the plurality of travel legs is represented by a travel leg node; a plurality of leg source nodes, wherein each travel leg of the plurality of travel legs has a leg source represented by a leg source node; a plurality of crew source nodes, wherein each crew member has a crew source represented by a crew source node; a plurality of cancellation nodes; a plurality of crew links; wherein each crew link extends between: a travel leg node; and a crew source node or another travel leg node; and wherein each of the crew links represents a flow of a crew member between: a travel leg represented by the travel leg node; and a crew source node or another travel leg represented by the another travel leg node; a plurality of reserve crew links; wherein each reserve crew link extends between: a travel leg node; and a crew source node or another travel leg node; and wherein each of the reserve crew links represents a flow of a reserve crew member between: a travel leg represented by the travel leg node; and a crew source node or another travel leg represented by the another leg travel node; a plurality of vehicle links; wherein each vehicle link extends between: a travel leg node; and a leg source node or another travel leg node; and wherein each of the vehicle links represents a flow of a vehicle between a travel leg represented by the travel leg node; and a leg source node or another travel leg represented by the another travel leg node; and a plurality of cancel links; wherein each cancel link extends between a cancellation node and a travel leg node; and wherein each of the cancel links represents cancellation of a travel leg associated with the linked travel leg node. In one embodiment, the recommended management plan further comprises feasible crew assignments and feasible vehicle assignments for the strategically delayed travel legs and the travel legs for which neither the strategic travel leg delays nor the strategic travel leg cancellations are applicable. In one embodiment, the feasible crew assignments and feasible vehicle assignments reduce disruptions for crew while maintaining vehicle routings. In one embodiment, the transportation-related data includes: gate capacity for a station that is a departure station and/or a destination station for any of the travel legs in the plurality of travel legs; wherein the gate capacity for the station is a number of gates that are available at the station; and a first gate demand threshold that is associated with a first type of delay; wherein receiving, using the computer, transportation-related data associated with the plurality of travel legs includes: displaying a gate demand display region on the user interface; displaying, in the gate demand display region, a first plurality of bars representing projected demand for gates at the station over a period of time, wherein a width of each bar of the first plurality of bars—along a time axis—represents a time period within a period of time, and a height of each bar of the first plurality of bars—along a demand axis that is perpendicular to the time axis—represents a total projected demand for gates in that time period; displaying, in the gate demand display region, a first line—extending parallel to the time axis—positioned perpendicular to the demand axis at a position representing the number of gates that are available at the station; displaying, in the gate demand display region, a second line—extending parallel to the time axis and the first line—positioned perpendicular to the demand axis at a position representing the first gate demand threshold; wherein the second line is selectable and movable along the demand axis; displaying, in the gate demand display region, a third line—extending parallel to the demand axis—positioned perpendicular to the time axis at a position representing the current time; and receiving instructions to change the first gate demand threshold via the gate demand display region, wherein the instructions to change the first gate demand threshold are received in response to the selection and movement of the second line along the demand axis; wherein the method further includes identifying, based on the transportation-related data and using the network model and the received changed first gate demand threshold, an updated recommended management plan that includes strategic travel leg delays for at least a portion of the travel legs and strategic travel leg cancellations for at least another portion of the travel legs. In one embodiment, the transportation-related data further includes a second gate demand threshold that is associated with a second type of delay; wherein receiving, using the computer, transportation-related data associated with the plurality of travel legs further includes: displaying, in the gate demand display region of the user interface, a fourth line—extending parallel to the time axis and the first line—positioned perpendicular to the demand axis at a position representing the second gate demand threshold; wherein the fourth line is selectable and movable along the demand axis; and receiving instructions to change the second gate demand threshold via the gate demand display region, wherein the instructions to change the second gate demand threshold are received in response to the selection and movement of the fourth line along the demand axis; and wherein identifying, based on the transportation-related data and using the network model and the received changed second gate demand threshold, the updated recommended management plan that includes strategic travel leg delays for at least a portion of the travel legs and strategic travel leg cancellations for at least another portion of the travel legs. In one embodiment, the transportation-related data includes: an arrival rate constraint value for a station that is a departure station and/or a destination station for any of the travel legs in the plurality of travel legs; and a flight arrival capacity for the station; wherein receiving, using the computer, transportation-related data associated with the plurality of travel legs includes: displaying, in a flight arrival display region of the user interface, a plurality of bars representing projected number of flight arrivals at the station over a period of time, wherein a width of each bar of the plurality of bars—along a time axis—represents a time period within the period of time, and a height of each bar of the plurality of bars—along a demand axis that is perpendicular to the time axis—represents a total projected flight arrival value in that time period; displaying, in the flight arrival display region, a first line—extending parallel to the time axis—positioned perpendicular to the demand axis at a position representing the flight arrival capacity for the station over the period of time; wherein the first line has a thickness that represents the arrival rate constraint value; and wherein the first line is selectable so that the thickness is adjustable to indicate a change in the arrival rate constraint value; displaying, in the flight arrival display region, a second line—extending parallel to the demand axis—positioned perpendicular to the time axis at a position representing the current time; and receiving instructions to change the arrival rate constraint value via the flight arrival display region, wherein the instructions to change the arrival rate constraint value are received in response to the selection of the first line and the adjustment of the thickness of the first line; and wherein the method further includes identifying, based on the transportation-related data and using the network model and the received changed arrival rate constraint value, an updated recommended management plan that includes strategic travel leg delays for at least a portion of the travel legs and strategic travel leg cancellations for at least another portion of the travel legs. In one embodiment, the transportation-related data includes: a departure rate constraint value for a station that is a departure station and/or a destination station for any of the travel legs in the plurality of travel legs; and a flight departure capacity for the station; wherein receiving, using the computer, transportation-related data associated with the plurality of travel legs includes: displaying a flight departure display region on the user interface; displaying, in the flight departure display region, a plurality of bars representing projected number of flight departures at the station over a period of time, wherein a width of each bar of the plurality of bars—along a time axis—represents a time period within the period of time, and a height of each bar of the plurality of bars—along a demand axis that is perpendicular to the time axis—represents a total projected flight departure value in that time period; displaying, in the flight departure display region, a first line—extending parallel to the time axis—positioned perpendicular to the demand axis at a position representing the flight departure capacity for the station over the period of time; wherein the first line has a thickness that represents the departure rate constraint value; wherein the first line is selectable so that the thickness is adjustable to indicate a change in the departure rate constraint value; displaying, in the flight departure display region, a second line—extending parallel to the demand axis—positioned perpendicular to the time axis at a position representing the current time; and receiving instructions to change the departure rate constraint value via the flight departure display region, wherein the instructions to change the departure rate constraint value are received in response to the selection of the first line and the adjustment of the thickness of the first line; wherein the method further includes identifying, based on the transportation-related data and using the network model and the received changed departure rate constraint value, an updated recommended management plan that includes strategic travel leg delays for at least a portion of the travel legs and strategic travel leg cancellations for at least another portion of the travel legs.

The present disclosure also provides a system including a non-transitory computer readable medium having stored thereon a plurality of instructions, wherein the instructions are executed with one or more processors so that the following steps are executed: receiving transportation-related data associated with a plurality of travel legs; wherein each travel leg in the plurality of travel legs is associated with a departure station and a destination station; and wherein the transportation-related data includes: travel leg data for each travel leg in the plurality of travel legs; and crew data for each travel leg in the plurality of travel legs; identifying a disruption to operations of the plurality of travel legs; generating, based on the transportation-related data, a network model; identifying, based on the transportation-related data and using the network model, a recommended management plan for the identified disruption, wherein the recommended management plan includes strategic travel leg delays for at least a portion of the travel legs and strategic travel leg cancellations for at least another portion of the travel legs; and wherein identifying the strategic travel leg delays and strategic travel leg cancellations includes: weighting a potential delay of a travel leg by an approximation of a number of misconnects that will result per time period of the potential delay; weighting, using slack variables, a potential delay of a travel leg and/or a potential cancellation of a travel leg to account for capacity constraints; and minimizing a sum of weighted potential delays plus a sum of weighted potential cancellations plus capacity violations; and outputting, on a user interface, at least a portion of the recommended management plan that includes the strategic travel leg delays for at least a portion of the travel legs and the strategic travel leg cancellations for at least another portion of the travel legs. In one embodiment, the network model includes: a plurality of travel leg nodes, wherein each travel leg of the plurality of travel legs is represented by a travel leg node; a plurality of leg source nodes, wherein each travel leg of the plurality of travel legs has a leg source represented by a leg source node; a plurality of crew source nodes, wherein each crew member has a crew source represented by a crew source node; a plurality of cancellation nodes; a plurality of crew links; wherein each crew link extends between: a travel leg node; and a crew source node or another travel leg node; and wherein each of the crew links represents a flow of a crew member between: a travel leg represented by the travel leg node; and a crew source node or another travel leg represented by the another travel leg node; a plurality of reserve crew links; wherein each reserve crew link extends between: a travel leg node; and a crew source node or another travel leg node; and wherein each of the reserve crew links represents a flow of a reserve crew member between: a travel leg represented by the travel leg node; and a crew source node or another travel leg represented by the another leg travel node; a plurality of vehicle links; wherein each vehicle link extends between: a travel leg node; and a leg source node or another travel leg node; and wherein each of the vehicle links represents a flow of a vehicle between a travel leg represented by the travel leg node; and a leg source node or another travel leg represented by the another travel leg node; and a plurality of cancel links; wherein each cancel link extends between a cancellation node and a travel leg node; and wherein each of the cancel links represents cancellation of a travel leg associated with the linked travel leg node. In one embodiment, the recommended management plan further comprises feasible crew assignments and feasible vehicle assignments for the strategically delayed travel legs and the travel legs for which neither the strategic travel leg delays nor the strategic travel leg cancellations are applicable. In one embodiment, the feasible crew assignments and feasible vehicle assignments reduce disruptions for crew while maintaining vehicle routings. In one embodiment, the transportation-related data includes: gate capacity for a station that is a departure station and/or a destination station for any of the travel legs in the plurality of travel legs; wherein the gate capacity for the station is a number of gates that are available at the station; and a first gate demand threshold that is associated with a first type of delay; wherein receiving, using the computer, transportation-related data associated with the plurality of travel legs includes: displaying a gate demand display region on the user interface; displaying, in the gate demand display region, a first plurality of bars representing projected demand for gates at the station over a period of time, wherein a width of each bar of the first plurality of bars—along a time axis—represents a time period within a period of time, and a height of each bar of the first plurality of bars—along a demand axis that is perpendicular to the time axis—represents a total projected demand for gates in that time period; displaying, in the gate demand display region, a first line—extending parallel to the time axis—positioned perpendicular to the demand axis at a position representing the number of gates that are available at the station; displaying, in the gate demand display region, a second line—extending parallel to the time axis and the first line—positioned perpendicular to the demand axis at a position representing the first gate demand threshold; wherein the second line is selectable and movable along the demand axis; displaying, in the gate demand display region, a third line—extending parallel to the demand axis—positioned perpendicular to the time axis at a position representing the current time; and receiving instructions to change the first gate demand threshold via the gate demand display region, wherein the instructions to change the first gate demand threshold are received in response to the selection and movement of the second line along the demand axis; wherein the instructions are executed with the one or more processors so that the following step is also executed: identifying, based on the transportation-related data and using the network model and the received changed first gate demand threshold, an updated recommended management plan that includes strategic travel leg delays for at least a portion of the travel legs and strategic travel leg cancellations for at least another portion of the travel legs. In one embodiment, the transportation-related data further includes a second gate demand threshold that is associated with a second type of delay; wherein receiving, using the computer, transportation-related data associated with the plurality of travel legs further includes: displaying, in the gate demand display region of the user interface, a fourth line—extending parallel to the time axis and the first line—positioned perpendicular to the demand axis at a position representing the second gate demand threshold; wherein the fourth line is selectable and movable along the demand axis; and receiving instructions to change the second gate demand threshold via the gate demand display region, wherein the instructions to change the second gate demand threshold are received in response to the selection and movement of the fourth line along the demand axis; and wherein identifying, based on the transportation-related data and using the network model and the received changed second gate demand threshold, the updated recommended management plan that includes strategic travel leg delays for at least a portion of the travel legs and strategic travel leg cancellations for at least another portion of the travel legs. In one embodiment, the transportation-related data includes: an arrival rate constraint value for a station that is a departure station and/or a destination station for any of the travel legs in the plurality of travel legs; and a flight arrival capacity for the station; wherein receiving, using the computer, transportation-related data associated with the plurality of travel legs includes: displaying, in a flight arrival display region of the user interface, a plurality of bars representing projected number of flight arrivals at the station over a period of time, wherein a width of each bar of the plurality of bars—along a time axis—represents a time period within the period of time, and a height of each bar of the plurality of bars—along a demand axis that is perpendicular to the time axis-represents a total projected flight arrival value in that time period; displaying, in the flight arrival display region, a first line—extending parallel to the time axis—positioned perpendicular to the demand axis at a position representing the flight arrival capacity for the station over the period of time; wherein the first line has a thickness that represents the arrival rate constraint value; and wherein the first line is selectable so that the thickness is adjustable to indicate a change in the arrival rate constraint value; displaying, in the flight arrival display region, a second line-extending parallel to the demand axis-positioned perpendicular to the time axis at a position representing the current time; and receiving instructions to change the arrival rate constraint value via the flight arrival display region, wherein the instructions to change the arrival rate constraint value are received in response to the selection of the first line and the adjustment of the thickness of the first line; and wherein the instructions are executed with the one or more processors so that the following step is also executed: identifying, based on the transportation-related data and using the network model and the received changed arrival rate constraint value, an updated recommended management plan that includes strategic travel leg delays for at least a portion of the travel legs and strategic travel leg cancellations for at least another portion of the travel legs. In one embodiment, the transportation-related data includes: a departure rate constraint value for a station that is a departure station and/or a destination station for any of the travel legs in the plurality of travel legs; and a flight departure capacity for the station; wherein receiving, using the computer, transportation-related data associated with the plurality of travel legs includes: displaying a flight departure display region on the user interface; displaying, in the flight departure display region, a plurality of bars representing projected number of flight departures at the station over a period of time, wherein a width of each bar of the plurality of bars—along a time axis—represents a time period within the period of time, and a height of each bar of the plurality of bars—along a demand axis that is perpendicular to the time axis—represents a total projected flight departure value in that time period; displaying, in the flight departure display region, a first line—extending parallel to the time axis—positioned perpendicular to the demand axis at a position representing the flight departure capacity for the station over the period of time; wherein the first line has a thickness that represents the departure rate constraint value; wherein the first line is selectable so that the thickness is adjustable to indicate a change in the departure rate constraint value; displaying, in the flight departure display region, a second line—extending parallel to the demand axis—positioned perpendicular to the time axis at a position representing the current time; and receiving instructions to change the departure rate constraint value via the flight departure display region, wherein the instructions to change the departure rate constraint value are received in response to the selection of the first line and the adjustment of the thickness of the first line; wherein the instructions are executed with the one or more processors so that the following step is also executed: identifying, based on the transportation-related data and using the network model and the received changed departure rate constraint value, an updated recommended management plan that includes strategic travel leg delays for at least a portion of the travel legs and strategic travel leg cancellations for at least another portion of the travel legs.

It is understood that variations may be made in the foregoing without departing from the scope of the disclosure. For example, instead of, or in addition to transportation transactions often conducted in the course of airline industry business, aspects of the present disclosure are applicable and/or readily adaptable to transportation transactions conducted in other industries, including rail, bus, cruise and other travel or shipping industries, rental car industries, hotels and other hospitality industries, entertainment industries, and other industries. In an example embodiment, aspects of the present disclosure are readily applicable and/or readily adaptable to a shipping transaction before, during or after which a ship travels from one port to another port and, in some case, on to one or more other ports. In an example embodiment, aspects of the present disclosure are readily applicable and/or readily adaptable to a trucking transaction before, during or after which a truck travels from one location to another location and, in some case, on to one or more other locations. In an example embodiment, aspects of the present disclosure are readily applicable and/or readily adaptable to a rail transaction before, during or after which a train travels from one city or station to another city or station and, in some cases, on to one or more other cities or stations. In an example embodiment, aspects of the present disclosure are applicable and/or readily adaptable to a wide variety of transportation transactions such as, for example, an airline sequence, a leg of an airline sequence, an airline block, and/or any combination thereof.

The entire disclosure of U.S. application Ser. No. 16/550,846, filed Aug. 26, 2019, is hereby incorporated herein by reference. The entire disclosure of U.S. application Ser. No. 13/755,766, filed Jan. 31, 2013, now U.S. Pat. No. 10,395,197, is hereby incorporated herein by reference.

In several example embodiments, the elements and teachings of the various illustrative example embodiments may be combined in whole or in part in some or all of the illustrative example embodiments. In addition, one or more of the elements and teachings of the various illustrative example embodiments may be omitted, at least in part, and/or combined, at least in part, with one or more of the other elements and teachings of the various illustrative embodiments.

Any spatial references such as, for example, “upper,” “lower,” “above,” “below,” “between,” “bottom,” “vertical,” “horizontal,” “angular,” “upwards,” “downwards,” “side-to-side,” “left-to-right,” “right-to-left,” “top-to-bottom,” “bottom-to-top,” “top,” “bottom,” “bottom-up,” “top-down,” etc., are for the purpose of illustration only and do not limit the specific orientation or location of the structure described above.

In several example embodiments, while different steps, processes, and procedures are described as appearing as distinct acts, one or more of the steps, one or more of the processes, and/or one or more of the procedures may also be performed in different orders, simultaneously and/or sequentially. In several example embodiments, the steps, processes and/or procedures may be merged into one or more steps, processes and/or procedures.

In several example embodiments, one or more of the operational steps in each embodiment may be omitted. Moreover, in some instances, some features of the present disclosure may be employed without a corresponding use of the other features. Moreover, one or more of the above-described embodiments and/or variations may be combined in whole or in part with any one or more of the other above-described embodiments and/or variations.

Although several example embodiments have been described in detail above, the embodiments described are example only and are not limiting, and those skilled in the art will readily appreciate that many other modifications, changes and/or substitutions are possible in the example embodiments without materially departing from the novel teachings and advantages of the present disclosure. Accordingly, all such modifications, changes and/or substitutions are intended to be included within the scope of this disclosure as defined in the following claims. In the claims, means-plus-function clauses are intended to cover the structures described herein as performing the recited function and not only structural equivalents, but also equivalent structures.

1-10. (canceled)

11. A method, comprising:
receiving, using a computer, transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying, using the computer, a disruption to operations of the plurality of travel legs;
generating, using the computer and based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface of the computer, at least a portion of the recommended management plan that comprises the strategic travel leg delays for at least a portion of the travel legs and the strategic travel leg cancellations for at least another portion of the travel legs;
wherein the transportation-related data further comprises a constraint value;
receiving instructions to change the constraint value via a display region on the user interface,
wherein the display region on the user interface comprises a line chart with a horizontal time axis representing a time period and a vertical axis representing constraint values,
wherein a first line extends parallel to the horizontal time axis and perpendicular to the vertical axis at a position representing the constraint value;
wherein the first line is grabbable and movable along the vertical axis;
wherein the first line has a thickness measured relative to the vertical axis;
wherein the movement of the first line relative to the vertical axis comprises moving the first line along the vertical axis while retaining the thickness of the first line; and
wherein the instructions to change the constraint value are received in response to the grabbing and movement of the first line relative to the vertical axis;
and
identifying, based on the transportation-related data and using the network model and the received changed constraint value, an updated recommended management plan.

12. (canceled)

13. The method of claim 11, wherein the recommended management plan further comprises feasible crew assignments and feasible vehicle assignments for the strategically delayed travel legs and travel legs for which neither the strategic travel leg delays nor the strategic travel leg cancellations are applicable.

14. The method of claim 13, wherein the feasible crew assignments and feasible vehicle assignments reduce disruptions for crew while maintaining vehicle routings.

15. A method, comprising:
receiving, using a computer, transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying, using the computer, a disruption to operations of the plurality of travel legs;
generating, using the computer and based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface of the computer, at least a portion of the recommended management plan that comprises the strategic travel leg delays for at least a portion of the travel legs and the strategic travel leg cancellations for at least another portion of the travel legs;
wherein the transportation-related data further comprises:
gate capacity for a station that is a departure station and/or a destination station for any of the travel legs in the plurality of travel legs;
wherein the gate capacity for the station is a number of gates that are available at the station; and
a first gate demand threshold that is associated with a first type of delay;
wherein receiving, using the computer, transportation-related data associated with the plurality of travel legs comprises:
displaying a gate demand display region on the user interface;
displaying, in the gate demand display region, a first plurality of bars representing projected demand for gates at the station over a period of time, wherein a width of each bar of the first plurality of bars—along a time axis—represents a time period within a period of time, and a height of each bar of the first plurality of bars—along a demand axis that is perpendicular to the time axis—represents a total projected demand for gates in that time period;
displaying, in the gate demand display region, a first line—extending parallel to the time axis—positioned perpendicular to the demand axis at a position representing the number of gates that are available at the station;
displaying, in the gate demand display region, a second line—extending parallel to the time axis and the first line—positioned perpendicular to the demand axis at a position representing the first gate demand threshold;
wherein the second line is grabbable and movable along the demand axis;
displaying, in the gate demand display region, a third line—extending parallel to the demand axis—positioned perpendicular to the time axis at a position representing the current time; and
receiving instructions to change the first gate demand threshold via the gate demand display region,
wherein the instructions to change the first gate demand threshold are received in response to the grabbing and movement of the second line along the demand axis;
and
identifying, based on the transportation-related data and using the network model and the received changed first gate demand threshold, an updated recommended management plan that comprises strategic travel leg delays for at least a portion of the travel legs and strategic travel leg cancellations for at least another portion of the travel legs.

16. The method of claim 15,
wherein the transportation-related data further comprises a second gate demand threshold that is associated with a second type of delay;
wherein receiving, using the computer, transportation-related data associated with the plurality of travel legs further comprises:
displaying, in the gate demand display region of the user interface, a fourth line—extending parallel to the time axis and the first line—positioned perpendicular to the demand axis at a position representing the second gate demand threshold;
wherein the fourth line is grabbable and movable along the demand axis;
and
receiving instructions to change the second gate demand threshold via the gate demand display region,
wherein the instructions to change the second gate demand threshold are received in response to the grabbing and movement of the fourth line along the demand axis;
and
wherein identifying, based on the transportation-related data and using the network model and the received changed second gate demand threshold, the updated recommended management plan that comprises strategic travel leg delays for at least a portion of the travel legs and strategic travel leg cancellations for at least another portion of the travel legs.

17. A method comprising:
receiving, using a computer, transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying, using the computer, a disruption to operations of the plurality of travel legs;
generating, using the computer and based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface of the computer, at least a portion of the recommended management plan that comprises the strategic travel leg delays for at least a portion of the travel legs and the strategic travel leg cancellations for at least another portion of the travel legs;
wherein the transportation-related data further comprises:
an arrival rate constraint value for a station that is a departure station and/or a destination station for any of the travel legs in the plurality of travel legs; and
a flight arrival capacity for the station;
wherein receiving, using the computer, transportation-related data associated with the plurality of travel legs comprises:
displaying, in a flight arrival display region of the user interface, a plurality of bars representing projected number of flight arrivals at the station over a period of time, wherein a width of each bar of the plurality of bars—along a time axis—represents a time period within the period of time, and a height of each bar of the plurality of bars—along a demand axis that is perpendicular to the time axis—represents a total projected flight arrival value in that time period;
displaying, in the flight arrival display region, a first line—extending parallel to the time axis—positioned perpendicular to the demand axis at a position representing the flight arrival capacity for the station over the period of time;
wherein the first line has a thickness that represents the arrival rate constraint value; and
wherein the first line is grabbable so that the thickness is adjustable to indicate a change in the arrival rate constraint value;
displaying, in the flight arrival display region, a second line-extending parallel to the demand axis-positioned perpendicular to the time axis at a position representing the current time; and
receiving instructions to change the arrival rate constraint value via the flight arrival display region,
wherein the instructions to change the arrival rate constraint value are received in response to the grabbing of the first line and the adjustment of the thickness of the first line;
and
identifying, based on the transportation-related data and using the network model and the received changed arrival rate constraint value, an updated recommended management plan that comprises strategic travel leg delays for at least a portion of the travel legs and strategic travel leg cancellations for at least another portion of the travel legs.

18. A method comprising:
receiving, using a computer, transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying, using the computer, a disruption to operations of the plurality of travel legs;
generating, using the computer and based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface of the computer, at least a portion of the recommended management plan that comprises the strategic travel leg delays for at least a portion of the travel legs and the strategic travel leg cancellations for at least another portion of the travel legs;
wherein the transportation-related data further comprises:
a departure rate constraint value for a station that is a departure station and/or a destination station for any of the travel legs in the plurality of travel legs; and
a flight departure capacity for the station;
wherein receiving, using the computer, transportation-related data associated with the plurality of travel legs comprises:
displaying a flight departure display region on the user interface;
displaying, in the flight departure display region, a plurality of bars representing projected number of flight departures at the station over a period of time, wherein a width of each bar of the plurality of bars—along a time axis—represents a time period within the period of time, and a height of each bar of the plurality of bars—along a demand axis that is perpendicular to the time axis—represents a total projected flight departure value in that time period;
displaying, in the flight departure display region, a first line—extending parallel to the time axis—positioned perpendicular to the demand axis at a position representing the flight departure capacity for the station over the period of time;
wherein the first line has a thickness that represents the departure rate constraint value;
wherein the first line is grabbable so that the thickness is adjustable to indicate a change in the departure rate constraint value;
displaying, in the flight departure display region, a second line-extending parallel to the demand axis-positioned perpendicular to the time axis at a position representing the current time; and
receiving instructions to change the departure rate constraint value via the flight departure display region,
wherein the instructions to change the departure rate constraint value are received in response to the grabbing of the first line and the adjustment of the thickness of the first line;
and
identifying, based on the transportation-related data and using the network model and the received changed departure rate constraint value, an updated recommended management plan that comprises strategic travel leg delays for at least a portion of the travel legs and strategic travel leg cancellations for at least another portion of the travel legs.

19. A system comprising a non-transitory computer readable medium having stored thereon a plurality of instructions, wherein the instructions are executed with one or more processors so that following steps are executed:
receiving transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying a disruption to operations of the plurality of travel legs;
generating, based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs; and
outputting, on a user interface, at least a portion of the recommended management plan that comprises the strategic travel leg delays for at least a portion of the travel legs and the strategic travel leg cancellations for at least another portion of the travel legs;
wherein the transportation-related data further comprises a constraint value;
receiving instructions to change the constraint value via a display region on the user interface,
wherein the display region on the user interface comprises a line chart with a horizontal time axis representing a time period and a vertical axis representing constraint values,
wherein a first line extends parallel to the horizontal time axis and perpendicular to the vertical axis at a position representing the constraint value;
wherein the first line is grabbable and movable along the vertical axis;
wherein the instructions to change the constraint value are received in response to the grabbing and movement of the first line relative to the vertical axis;
wherein the first line has a thickness measured relative to the vertical axis; and
wherein the movement of the first line relative to the vertical axis comprises moving the first line along the vertical axis while retaining the thickness of the first line;
and
identifying, based on the transportation-related data and using the network model and the received changed constraint value, an updated recommended management plan.

20. (canceled)

21. A system comprising a non-transitory computer readable medium having stored thereon a plurality of instructions, wherein the instructions are executed with one or more processors so that following steps are executed:
receiving transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying a disruption to operations of the plurality of travel legs;
generating, based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface, at least a portion of the recommended management plan that comprises the strategic travel leg delays for at least a portion of the travel legs and the strategic travel leg cancellations for at least another portion of the travel legs;
wherein the transportation-related data comprises:
gate capacity for a station that is a departure station and/or a destination station for any of the travel legs in the plurality of travel legs;
wherein the gate capacity for the station is a number of gates that are available at the station; and
a first gate demand threshold that is associated with a first type of delay;
wherein receiving transportation-related data associated with the plurality of travel legs comprises:
displaying a gate demand display region on the user interface;
displaying, in the gate demand display region, a first plurality of bars representing projected demand for gates at the station over a period of time, wherein a width of each bar of the first plurality of bars—along a time axis—represents a time period within a period of time, and a height of each bar of the first plurality of bars—along a demand axis that is perpendicular to the time axis—represents a total projected demand for gates in that time period;
displaying, in the gate demand display region, a first line—extending parallel to the time axis—positioned perpendicular to the demand axis at a position representing the number of gates that are available at the station;
displaying, in the gate demand display region, a second line—extending parallel to the time axis and the first line—positioned perpendicular to the demand axis at a position representing the first gate demand threshold;
wherein the second line is grabbable and movable along the demand axis;
displaying, in the gate demand display region, a third line—extending parallel to the demand axis—positioned perpendicular to the time axis at a position representing the current time; and
receiving instructions to change the first gate demand threshold via the gate demand display region,
wherein the instructions to change the first gate demand threshold are received in response to the grabbing and movement of the second line along the demand axis;
and
identifying, based on the transportation-related data and using the network model and the received changed first gate demand threshold, an updated recommended management plan that comprises strategic travel leg delays for at least a portion of the travel legs and strategic travel leg cancellations for at least another portion of the travel legs.

22. The system of claim 19, wherein the recommended management plan further comprises feasible crew assignments and feasible vehicle assignments for the strategically delayed travel legs and travel legs for which neither the strategic travel leg delays nor the strategic travel leg cancellations are applicable.

23. The system of claim 22, wherein the feasible crew assignments and feasible vehicle assignments reduce disruptions for crew while maintaining vehicle routings.

24. The system of claim 21,
wherein the transportation-related data further comprises a second gate demand threshold that is associated with a second type of delay;
wherein receiving transportation-related data associated with the plurality of travel legs further comprises:
displaying, in the gate demand display region of the user interface, a fourth line—extending parallel to the time axis and the first line—positioned perpendicular to the demand axis at a position representing the second gate demand threshold;
wherein the fourth line is grabbable and movable along the demand axis;
and
receiving instructions to change the second gate demand threshold via the gate demand display region,
wherein the instructions to change the second gate demand threshold are received in response to the grabbing and movement of the fourth line along the demand axis;
and
wherein identifying, based on the transportation-related data and using the network model and the received changed second gate demand threshold, the updated recommended management plan that comprises strategic travel leg delays for at least a portion of the travel legs and strategic travel leg cancellations for at least another portion of the travel legs.

25. A system comprising a non-transitory computer readable medium having stored thereon a plurality of instructions, wherein the instructions are executed with one or more processors so that following steps are executed:
receiving transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying a disruption to operations of the plurality of travel legs;
generating, based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface, at least a portion of the recommended management plan that comprises the strategic travel leg delays for at least a portion of the travel legs and the strategic travel leg cancellations for at least another portion of the travel legs;
wherein the transportation-related data further comprises:
an arrival rate constraint value for a station that is a departure station and/or a destination station for any of the travel legs in the plurality of travel legs; and
a flight arrival capacity for the station;
wherein receiving transportation-related data associated with the plurality of travel legs comprises:
displaying, in a flight arrival display region of the user interface, a plurality of bars representing projected number of flight arrivals at the station over a period of time, wherein a width of each bar of the plurality of bars—along a time axis—represents a time period within the period of time, and a height of each bar of the plurality of bars—along a demand axis that is perpendicular to the time axis—represents a total projected flight arrival value in that time period;
displaying, in the flight arrival display region, a first line—extending parallel to the time axis—positioned perpendicular to the demand axis at a position representing the flight arrival capacity for the station over the period of time;
wherein the first line has a thickness that represents the arrival rate constraint value; and
wherein the first line is grabbable so that the thickness is adjustable to indicate a change in the arrival rate constraint value;
displaying, in the flight arrival display region, a second line—extending parallel to the demand axis—positioned perpendicular to the time axis at a position representing the current time; and
receiving instructions to change the arrival rate constraint value via the flight arrival display region,
wherein the instructions to change the arrival rate constraint value are received in response to the grabbing of the first line and the adjustment of the thickness of the first line;
and
identifying, based on the transportation-related data and using the network model and the received changed arrival rate constraint value, an updated recommended management plan that comprises strategic travel leg delays for at least a portion of the travel legs and strategic travel leg cancellations for at least another portion of the travel legs.

26. A system comprising a non-transitory computer readable medium having stored thereon a plurality of instructions, wherein the instructions are executed with one or more processors so that following steps are executed:
receiving transportation-related data associated with a plurality of travel legs;
wherein each travel leg in the plurality of travel legs is associated with a departure station and a destination station; and
wherein the transportation-related data comprises:
travel leg data for each travel leg in the plurality of travel legs; and
crew data for each travel leg in the plurality of travel legs;
identifying a disruption to operations of the plurality of travel legs;
generating, based on the transportation-related data, a network model;
identifying, based on the transportation-related data and using the network model, a recommended management plan for the identified disruption,
wherein the recommended management plan comprises strategic travel leg delays for at least a portion of the travel legs and strategic travel leg cancellations for at least another portion of the travel legs;
outputting, on a user interface, at least a portion of the recommended management plan that comprises the strategic travel leg delays for at least a portion of the travel legs and the strategic travel leg cancellations for at least another portion of the travel legs;
wherein the transportation-related data further comprises:
a departure rate constraint value for a station that is a departure station and/or a destination station for any of the travel legs in the plurality of travel legs; and
a flight departure capacity for the station;
wherein receiving transportation-related data associated with the plurality of travel legs comprises:
displaying a flight departure display region on the user interface;
displaying, in the flight departure display region, a plurality of bars representing projected number of flight departures at the station over a period of time, wherein a width of each bar of the plurality of bars—along a time axis—represents a time period within the period of time, and a height of each bar of the plurality of bars—along a demand axis that is perpendicular to the time axis—represents a total projected flight departure value in that time period;
displaying, in the flight departure display region, a first line—extending parallel to the time axis—positioned perpendicular to the demand axis at a position representing the flight departure capacity for the station over the period of time;
wherein the first line has a thickness that represents the departure rate constraint value;
wherein the first line is grabbable so that the thickness is adjustable to indicate a change in the departure rate constraint value;
displaying, in the flight departure display region, a second line—extending parallel to the demand axis—positioned perpendicular to the time axis at a position representing the current time; and
receiving instructions to change the departure rate constraint value via the flight departure display region,
wherein the instructions to change the departure rate constraint value are received in response to the grabbing of the first line and the adjustment of the thickness of the first line;
and
identifying, based on the transportation-related data and using the network model and the received changed departure rate constraint value, an updated recommended management plan that comprises strategic travel leg delays for at least a portion of the travel legs and strategic travel leg cancellations for at least another portion of the travel legs.

27. (canceled)

28. The method of claim 11,
wherein the first line has a thickness measured relative to the vertical axis; and
wherein the movement of the first line relative to the vertical axis comprises an adjustment of the thickness of the first line.

29. (canceled)

30. The system of claim 19,
wherein the first line has a thickness measured relative to the vertical axis; and
wherein the movement of the first line relative to the vertical axis comprises an adjustment of the thickness of the first line.

31. The method of claim 15, wherein the recommended management plan further comprises feasible crew assignments and feasible vehicle assignments for the strategically delayed travel legs and travel legs for which neither the strategic travel leg delays nor the strategic travel leg cancellations are applicable.

32. The method of claim 31, wherein the feasible crew assignments and feasible vehicle assignments reduce disruptions for crew while maintaining vehicle routings.

33. The method of claim 17, wherein the recommended management plan further comprises feasible crew assignments and feasible vehicle assignments for the strategically delayed travel legs and travel legs for which neither the strategic travel leg delays nor the strategic travel leg cancellations are applicable.

34. The method of claim 33, wherein the feasible crew assignments and feasible vehicle assignments reduce disruptions for crew while maintaining vehicle routings.

35. The method of claim 18, wherein the recommended management plan further comprises feasible crew assignments and feasible vehicle assignments for the strategically delayed travel legs and travel legs for which neither the strategic travel leg delays nor the strategic travel leg cancellations are applicable.

36. The method of claim 35, wherein the feasible crew assignments and feasible vehicle assignments reduce disruptions for crew while maintaining vehicle routings.

37. The system of claim 21, wherein the recommended management plan further comprises feasible crew assignments and feasible vehicle assignments for the strategically delayed travel legs and travel legs for which neither the strategic travel leg delays nor the strategic travel leg cancellations are applicable.

38. The system of claim 37, wherein the recommended management plan further comprises feasible crew assignments and feasible vehicle assignments for the strategically delayed travel legs and the travel legs for which neither the strategic travel leg delays nor the strategic travel leg cancellations are applicable.

39. The system of claim 25, wherein the recommended management plan further comprises feasible crew assignments and feasible vehicle assignments for the strategically delayed travel legs and travel legs for which neither the strategic travel leg delays nor the strategic travel leg cancellations are applicable.

40. The system of claim 39, wherein the recommended management plan further comprises feasible crew assignments and feasible vehicle assignments for the strategically delayed travel legs and the travel legs for which neither the strategic travel leg delays nor the strategic travel leg cancellations are applicable.

41. The system of claim 26, wherein the recommended management plan further comprises feasible crew assignments and feasible vehicle assignments for the strategically delayed travel legs and travel legs for which neither the strategic travel leg delays nor the strategic travel leg cancellations are applicable.

42. The system of claim 41, wherein the recommended management plan further comprises feasible crew assignments and feasible vehicle assignments for the strategically delayed travel legs and the travel legs for which neither the strategic travel leg delays nor the strategic travel leg cancellations are applicable.
